(19) United States
(12) Patent Application Publication
(10) Pub. No.: US 2018/0319570 A1
(43) Pub. Date: Nov. 8, 2018

(54) DISPENSER

(71) Applicant: Access Business Group International LLC, Ada, MI (US)

(72) Inventors: David W. Baarman, Fennville, MI (US); Colin J. Moore, Grand Rapids, MI (US); Cody D. Dean, Grand Rapids, MI (US); Ryan D. Schamper, Grand Haven, MI (US); Sean T. Eurich, Holland, MI (US); Merdad Veiseh, Spring Lake, MI (US); Dan Parker, Grand Rapids, MI (US); Joseph C. Van Den Brink, Coopersville, MI (US); Richard J. Weber, Grand Haven, MI (US)

(21) Appl. No.: 16/040,109

(22) Filed: Jul. 19, 2018

Related U.S. Application Data
(63) Continuation of application No. 14/661,072, filed on Mar. 18, 2015.
(60) Provisional application No. 61/968,822, filed on Mar. 21, 2014.

(51) Int. Cl. B65D 83/04; B65D 47/26; B65D 47/08; A61J 7/00; A61J 1/03; A61J 7/04

(52) U.S. Cl. CPC B65D 83/0409; B65D 83/0481; B65D 83/0427; B65D 47/265; B65D 47/0885; A61J 7/0084; A61J 2205/60; A61J 7/0418; A61J 7/0436; A61J 7/0463; A61J 7/0454; A61J 7/0445; A61J 2200/30; A61J 1/03

(57) ABSTRACT

A dispenser or dispensing system. The dispenser can be a screw conveyor pill dispenser, tumbler pill dispenser, push-to-operate pill cap dispenser, twist-to-operate pill cap dispenser, or push-to-operate pill cap dispenser. The pill dispenser may include a pill dispenser control system that can interact with a personal device, such as a smart phone. The pill dispenser control system can implement communication with a personal device, pill identification, user identification and security, scheduling functions, and notifications. The pill dispenser can dispense pills manually, semi-automatically, or automatically.

### BACKGROUND OF THE INVENTION

The present invention relates to a dispenser system including one or more dispensers.

Virtually everyone consumes prescription medication or over-the-counter vitamins or supplements at one time or another. One issue that the industry faces is related to compliance in taking the medication, supplement, vitamin, etc. Often, consumers buy multivitamins, fish oil, vitamin C, etc., yet only take them 30-60% of the recommended or prescribed time. A device that can automatically or otherwise facilitate dispensing the pills associated with an individual may increase compliance.

There can be hygiene issues with conventional pill bottles. Typically, a person opens the bottle and pours the pills into their hand; any excess pills are returned to the bottle. If the bottle is for a single user, this may not be an issue. However, often a bottle is accessible to many individuals; for example, a communal aspirin bottle in an office. It can be unsanitary for multiple people to touch and subsequently replace the pills, especially given that the person may be sick.

In the case of multiple users, convenience is also a factor. Each user has their own prescriptions and preferences of pills they take. Purchasing separate pill bottles of the same pills—one for each user is inefficient and cost ineffective.

### SUMMARY OF THE INVENTION

One aspect of the present invention provides an electro-mechanical screw conveyor pill dispenser. The screw conveyor pill dispenser may include a pill container, a screw conveyor including an axel, a scoop assembly, and a motor. In operation, the motor rotates the screw conveyor axel. As the screw is rotated, one or more pills ride up the bottom angled surface of the pill container. Near the end of the pill container, a scoop assembly coupled to the axel scoops up the pill and dispenses it out an opening in the pill container. A sensor may be included to detect dispensing of a pill and shut off the motor. The scoop assembly may include a wall for sealing the pill container after dispensing a pill.

Some embodiments of the electro-mechanical screw conveyor are modular and can be expanded by adding modules vertically and/or horizontally. The modules and base unit can include electrical contacts or wireless power for transferring power or data therebetween.

One embodiment of the screw conveyor pill dispenser includes an integrated screw pill container that rotates as a unit. In this embodiment, a disposable or reusable pill container may include helical pill guides that act as a screw conveyor when a motor rotates the entire pill container.

Some embodiments of the screw conveyor pill dispenser can accommodate an adjustable scoop assembly. For example, different scoop assemblies with different size scoops can be removably attached to the screw conveyor axel. In an alternative embodiment, a scoop assembly can be selectively adjustable to different scoop sizes.

Another aspect of the present invention provides a tumbler pill dispenser. The tumbler pill dispenser includes a pill container including one or more pockets, a shroud having an opening, and a gear. The pill container can be rotated via the gear in order to dispense one or more pills. The shroud 25 can restrict pills from dispensing until the pill container 24 is rotated to an ejecting location where the pill container pocket and the shroud opening align. The gear can be rotated manually or by a motor. Multiple tumbler pill dispensers can be arranged side-by-side to form a dispenser system. Power and or communication can be passed therebetween via electrical contacts or wirelessly. In some embodiments, the pill container for the tumbler pill dispenser can be sold separately as a sealed pill package for installation into a tumbler pill dispenser.

Another aspect of the present invention provides a single pill dispenser that is a push-to-operate type pill dispenser. The dispenser includes an inner housing, an outer housing, and one or more spring members disposed between the inner and outer housings. The inner housing has a side wall with a window formed therethrough, a threaded neck adapted to mount to an externally threaded bottle, and a funnel-shaped interior chamber communicating between the neck and the window. The outer housing has a side wall with a dispenser window formed therethrough, and a ledge disposed below the dispenser window. In use, depressing the bottle aligns the window and dispenser window such that a pill in the interior chamber falls through the aligned windows and onto the ledge for dispensing to a user. According to another embodiment, the dispensers can be of different size based on the size of the pill, and multiple units can be placed together to create a family or grouping of pill dispensers. Further, the dispensers can have LEDs to notify the user that a pill needs to be taken. An accelerometer can count how many pills have been dispensed and the LED can indicate that pills need to be reordered.

Another aspect of the present invention provides a pill dispenser that is a twist-to-operate type pill dispenser. A first embodiment of the pill dispenser includes a rotatable cap, a threaded collar, and a rotating funnel. The rotatable cap has a dispensing window therethrough. The threaded collar includes an intermediate window, a center hole, and an internally threaded flange adapted to mount to an externally threaded bottle. The rotating funnel has an interior window and a funnel that tapers toward the interior window. In use, turning the cap selectively aligns the dispensing window, intermediate window, and interior window, such that when the bottle is inverted or angled up-side down a pill in the bottle falls through the aligned windows for dispensing to a user.

A second embodiment of the twist-to-operate type pill dispenser includes a housing and a rotatable cap that has a dispensing window. The housing includes at least two funnels that transition from a lower surface to an upper surface of the housing and define at least two openings therethrough. The housing also includes a threaded collar adapted to mount to an externally threaded bottle. In use, rotating the cap selectively aligns the dispensing window and one of the at least two openings of the funnels, such that when the bottle is inverted or angled up-side down a pill contained within the bottle falls through the aligned dispensing window and opening for dispensing to a user.

Yet another aspect of the present invention provides a pill dispenser that is a flip-to-operate type pill dispenser. The pill dispenser includes a hinged cap and a housing. The cap has a ramped surface on an interior thereof and is hingedly mounted to the housing. The housing includes a tray, an opening, and an internally threaded collar adapted to mount to an externally threaded bottle. In use, inverting the bottle causes a pill contained within the bottle to fall through the housing opening and be directed by the ramp on the interior of the cap toward the tray for dispensing to a user. This makes it easy to grab a single pill. Further, LEDs could be incorporated into the design to notify the user that there has not been a pill dispensed in a given amount of time.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 illustrates a perspective view of one embodiment of a screw conveyor dispenser.

FIG. 2 illustrates an exploded view of the screw conveyor dispenser.

FIG. 3 illustrates a top view of the screw conveyor dispenser.

FIG. 4 illustrates a perspective view of one embodiment of a vertically stackable screw conveyor dispenser.

FIG. 5 illustrates an exploded view of the vertically stackable screw conveyor dispenser.

FIG. 6 illustrates a cut-away view of the vertically stackable screw conveyor dispenser.

FIG. 7 illustrates a perspective view of a horizontally and vertically stackable screw conveyor dispenser.

FIG. 8 is a perspective view of a pill dispenser and pill bottle according to one aspect of the present invention.

FIG. 9 is an exploded view of the pill dispenser and pill bottle of FIG. 8.

FIG. 10 is perspective view of multiple pill dispensers and pill bottles, according to another embodiment of the present invention.

FIG. 11 is a perspective view of a pill dispenser and pill bottle according to one aspect of the present invention.

FIG. 12 is an exploded view of the pill dispenser and pill bottle of FIG. 11.

FIG. 13 is a perspective view of a pill dispenser and pill bottle according to one aspect of the present invention.

FIG. 14A is a perspective view of the pill dispenser of FIG. 13, illustrating an open position, and including a pill.

FIG. 14B is a perspective view of a housing of the pill dispenser of FIG. 13.

FIG. 15 is an exploded view of the pill dispenser and pill bottle of FIG. 13.

FIG. 16 is a perspective view of the pill dispenser and pill bottle of FIG. 13, illustrating an open position, and including a pill.

FIG. 17 is a perspective view of a mechanical tumbler pill dispenser.

FIG. 18 is a perspective view of a mechanical tumbler pill dispenser in an actuated position.

FIG. 19 is a perspective view of an electro-mechanical tumbler pill dispenser.

FIG. 20 is an exploded view of an electro-mechanical tumbler pill dispenser.

FIG. 21A is a cut-away view of an electro-mechanical tumbler pill dispenser showing operation.

FIG. 21B is a cut-away view of an electro-mechanical tumbler pill dispenser showing the dispensing angle.

FIG. 22 is a perspective view of a mechanical tumbler pill dispenser with tray catch.

FIGS. 23A-C are perspective views of the pill dispenser and pill bottle of FIG. 11, illustrating open and closed positions of the pill dispenser.

FIG. 24A is a top view of the pill dispenser and pill bottle of FIG. 13, illustrating the opened position of the pill dispenser.

FIG. 24B is a side perspective view of the pill dispenser and pill bottle of FIG. 13, illustrating the closed position of the pill dispenser.

FIG. 25 is front view of multiple pill dispensers and pill bottles of FIG. 10.

FIG. 26A illustrates a front view of a horizontally and vertically stackable screw conveyor dispenser.

FIG. 26B illustrates a perspective view of a horizontally and vertically stackable screw conveyor dispenser.

FIG. 27 is a perspective view of a horizontally stacked tumbler pill dispenser.

FIGS. 28A-D illustrate personal device screenshots relating to pill dispenser control system scheduling.

FIG. 29 illustrates a logic category diagram of pill identification.

FIG. 30A illustrates a perspective view of a horizontally stackable screw conveyor with a flat surface travel container configuration.

FIG. 30B illustrates a perspective view of a horizontally stackable screw conveyor with a removable and slidable travel container configuration.

FIG. 31 illustrates a side view of a vertically stackable screw conveyor with lighting.

FIG. 32 illustrates a side view of a plurality of tumbler pill dispensers and a connection point to share electrical power and data between units.

FIG. 33 illustrates a cut away view of an electro-mechanical tumbler pill dispenser with lighting.

FIG. 34 illustrates a perspective view of a plurality of tumbler pill dispensers and a master unit.

FIG. 35 illustrates an exploded view of a plurality of tumbler pill dispensers and a master unit.

FIG. 36 illustrates a perspective view of a plurality of tumbler pill dispensers and a master unit with a removable travel container.

FIGS. 37A-D illustrate various communication scenarios between a personal device and pill dispensers.

FIG. 38A illustrates a communication scenario with a personal device having a switch for modulating.

FIG. 38B illustrates a communication scenario between a pill cap dispenser and a personal device.

FIG. 39 illustrates a security scenario between a personal device and a pill dispenser system.

FIG. 40 illustrates a logic diagram of automatic pill identification and a Raman spectroscopy graph.

FIG. 41 illustrates a perspective view of a screw conveyor pill dispenser with the angle of the pill container.

FIG. 42 illustrates a perspective view of an alternative screw conveyor dispenser with an integrated screw pill container.

FIG. 43A illustrates a pill container having an integrated pill identifier and system for reading same.

FIG. 43B illustrates a top view of a hinge/spring actuator.

FIG. 43C illustrates a perspective view of a hinge/spring actuator.

FIG. 44 illustrates a communication path between a pill container, pill dispenser, and personal device including the Internet.

FIG. 45 illustrates a perspective view of three different size scoops for use with a screw conveyor dispenser.

FIG. 46 illustrates a block diagram of a control system for a dispenser.

FIG. 47 illustrates a block diagram of a control system for a dispenser and control system for a device.

FIG. 48 is a perspective view of a pill dispenser according to another aspect of the present invention.

FIG. 49 is a lower perspective view of the pill dispenser of FIG. 48.

FIG. 50 is a bottom view of the pill dispenser of FIG. 48.

FIG. 51 illustrates a perspective view of an adjustable scoop for use with a screw conveyor dispenser.

FIG. 52 illustrates a perspective view of a pill container with a removable seal.

FIG. 53 illustrates horizontally and vertically stackable screw conveyor dispenser and a travel pill container according to another aspect of the present invention.

FIG. 54 illustrates filling of the travel pill container of FIG. 53.

FIG. 55 illustrates horizontally and vertically stackable screw conveyor dispenser and a removable tray according to another aspect of the present invention.

FIG. 56 illustrates removing the removable tray of FIG. 55.

FIG. 57 illustrates using the removable tray of FIG. 55 to fill a travel pill container.

FIG. 58 is a perspective view of a pill dispenser according to another aspect of the present invention.

FIG. 59 is a bottom view of the pill dispenser of FIG. 58.

FIG. 60 is a front view of the pill dispenser of FIG. 58.

FIG. 61 is a cross-sectional view of the pill dispenser taken along line 61-61 of FIG. 60.

FIG. 62 is a perspective view of the pill dispenser of FIG. 58, illustrating a push bar in a raised, dispensing position.

FIG. 63 is a bottom view of the pill dispenser of FIG. 62.

FIG. 64 is a front view of the pill dispenser of FIG. 62.

FIG. 65 is a cross-sectional view of the pill dispenser taken along line 65-65 of FIG. 64.

FIG. 66 is a bottom perspective view of the pill dispenser of FIG. 58.

### DESCRIPTION OF THE CURRENT EMBODIMENT

The present invention is directed to a variety of manual, semi-automatic, and automatic dispensers that can regulate or restrict the number of pills dispensed. One aspect of the invention is directed to a screw conveyer and scoop dispenser. Another aspect of the invention is directed to a ratchet and scoop dispenser. Yet another aspect of the invention is directed to a push-to-operate dispenser. Yet another aspect of the invention is directed to a twist-to-operate dispenser. Yet another aspect of the invention is directed to a flip-to-operate dispenser.

Although the present invention is described largely in the context of dispensing pills, it should be understood that the dispensers can be configured to dispense essentially any article or pill sized item. For example, the dispensers can dispense a variety of different articles, such as pills, capsules, tablets, caplets, candy and other similarly shaped items, such as capsule shaped articles, oval shaped articles, spherical shaped articles, lozenge shaped articles, or STD Cup. To provide some examples, the dispensers can dispense multi-vitamins, heart rate medication, diabetes medication, vitamin C pills, Nutrilite Double X, Nutrilite Vitamin C Plus, Nutrilite Cal Mag D Advanced, Nutrilite Natural B Complex, Nutrilite Lecithin-E Chewables, Nutrilite Vision Health w/Lutein, Nutrilite Glucosamine 7, or other supplements.

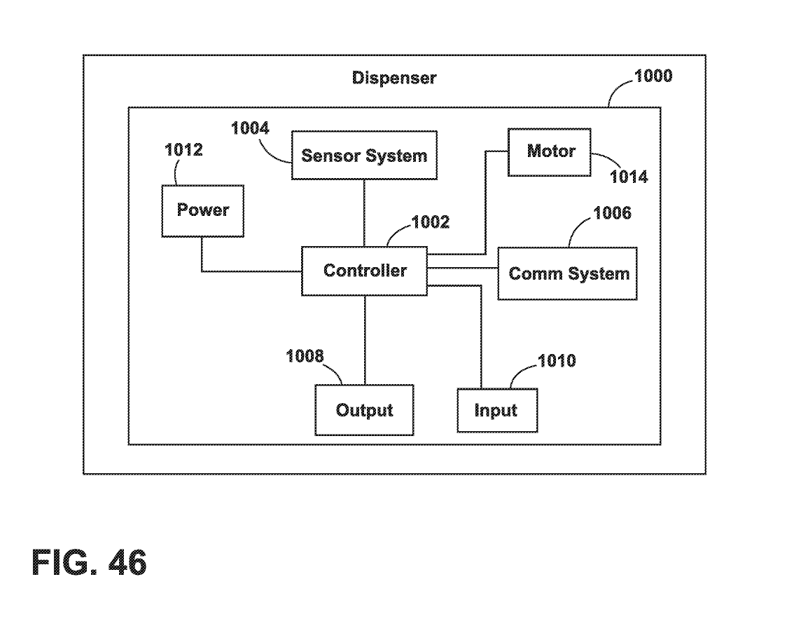

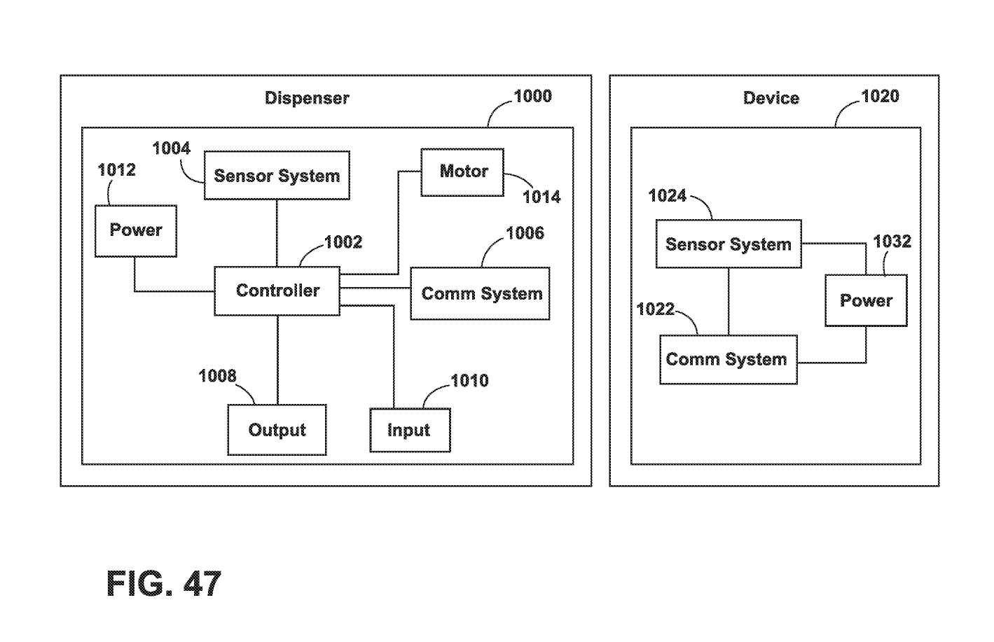

The dispensers may include a control system with a variety of components. For example, some embodiments may include a control system with a controller 1002, a sensor system 1004, a communication system 1006, an input 1010, an output 1008, and a power source or power connector 1012, as depicted in FIG. 46 or 47. The control system 1000 may be configured to provide automatic dispensing, semi-automatic dispensing, security, communication, pill identification, user identification and security, notification, or other functionality. In one embodiment, the control system can be configured to dispense a single pill or a pre-defined number of pills.

A dispenser may communicate with a mobile device, such as a smart phone, laptop, or weight management device. The device may include a control system 1020. For example, the control system may include a sensor system 1024, a communication system 1022, and a power source or power connector 1032.

A number of different embodiments of dispensers are discussed below. After that, a number of features that can be incorporated into the various constructions are discussed.

I. Screw Conveyer Dispenser

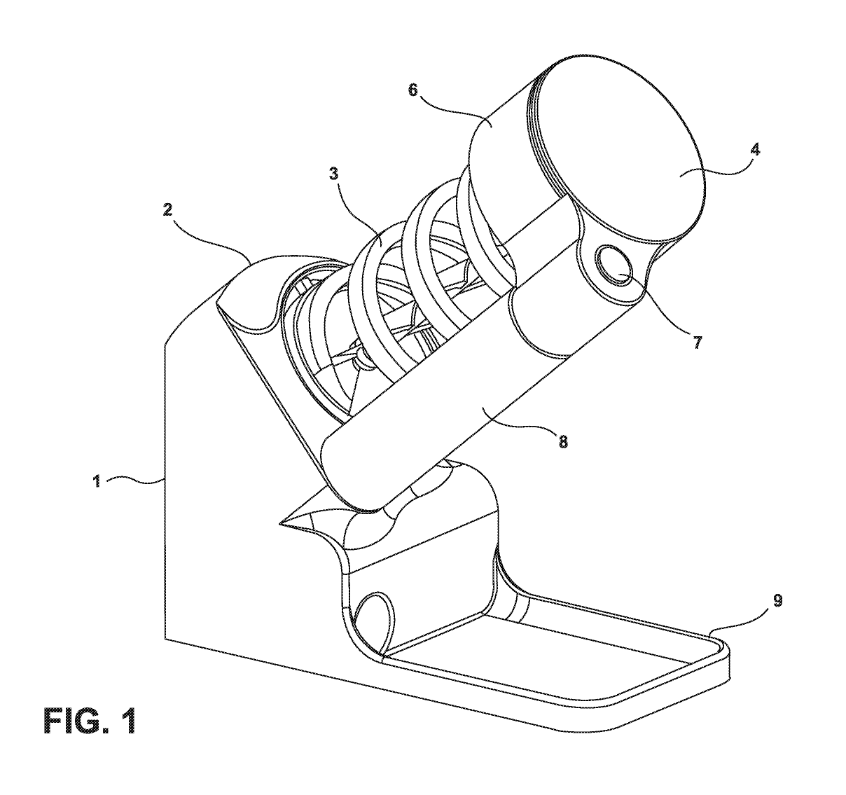

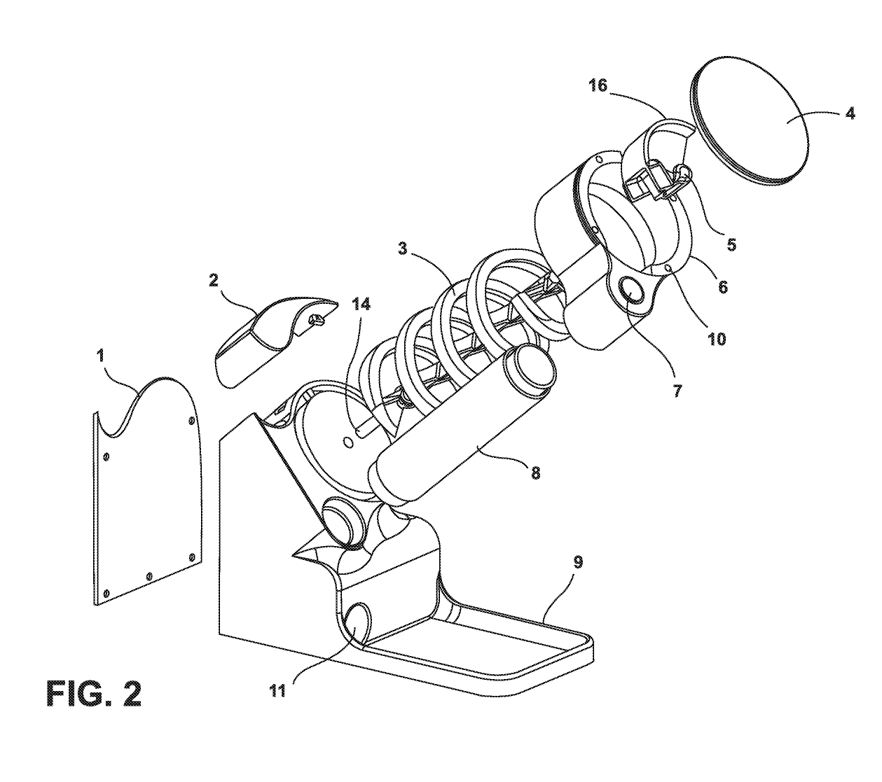

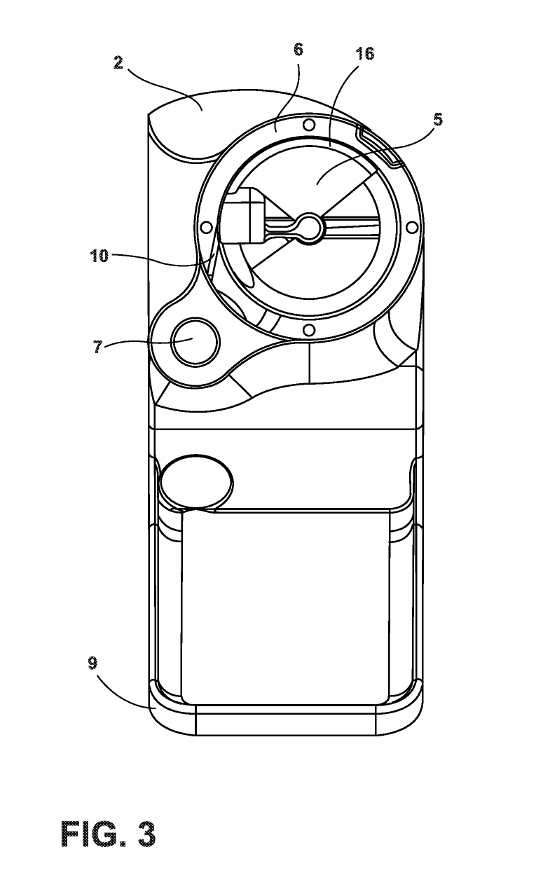

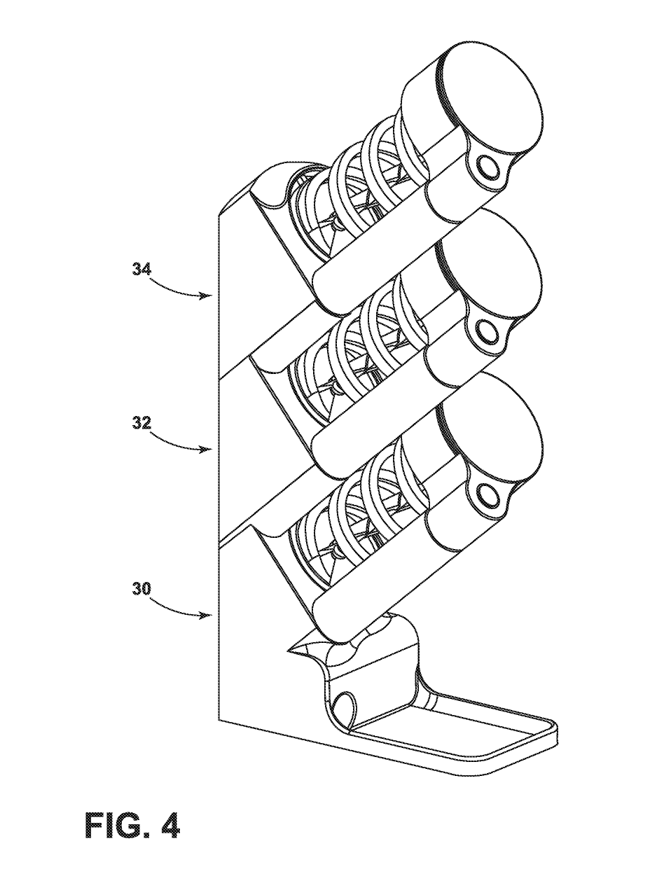

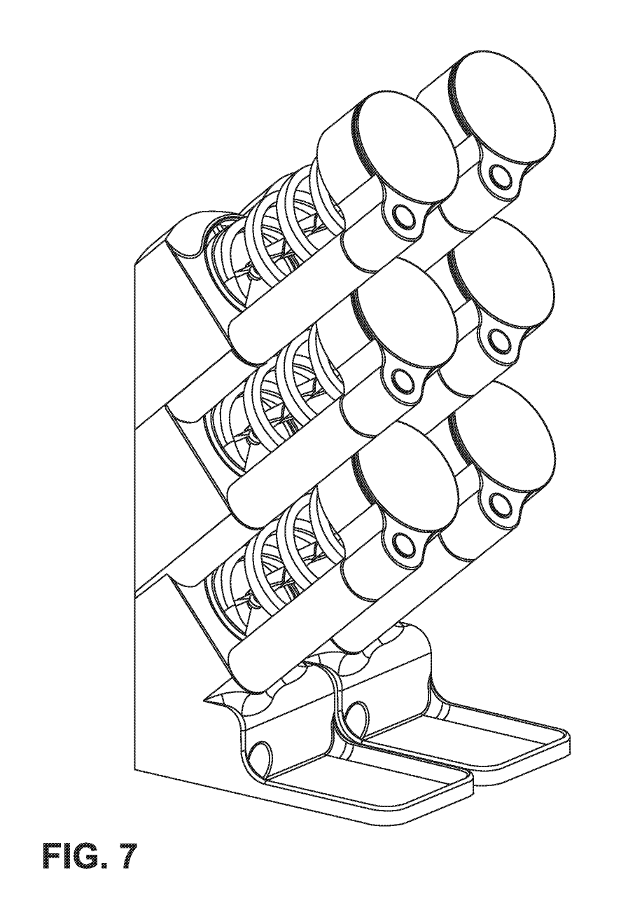

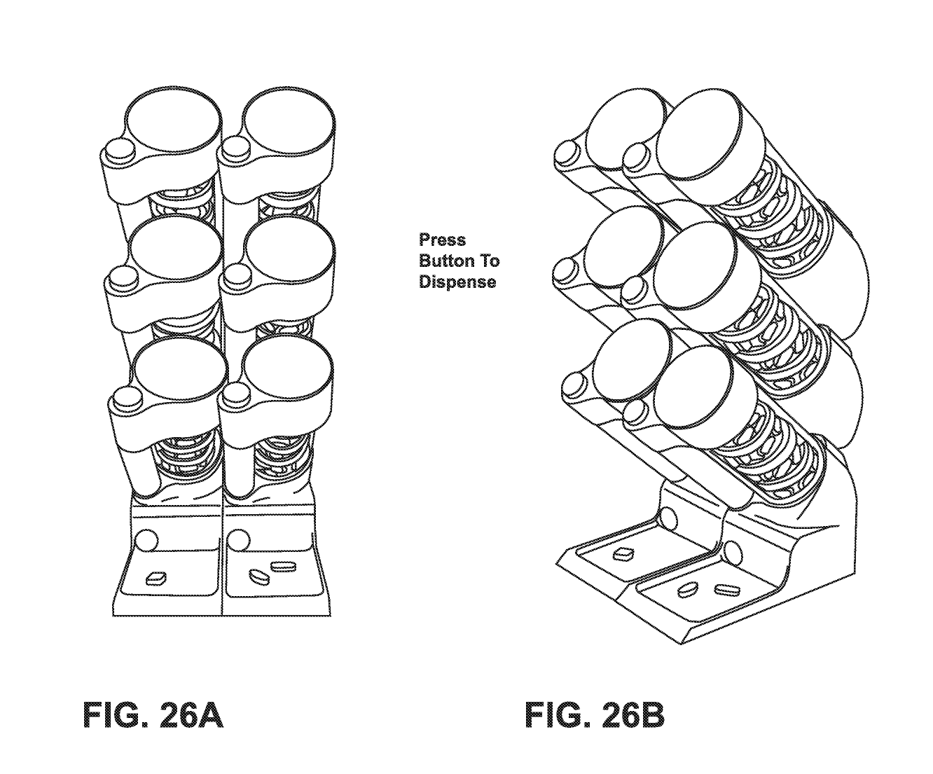

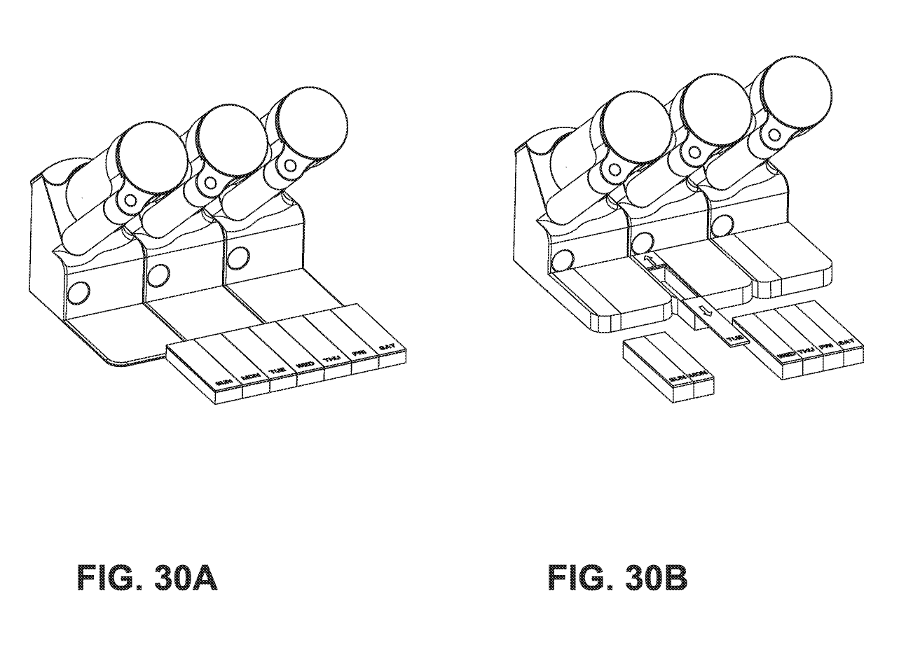

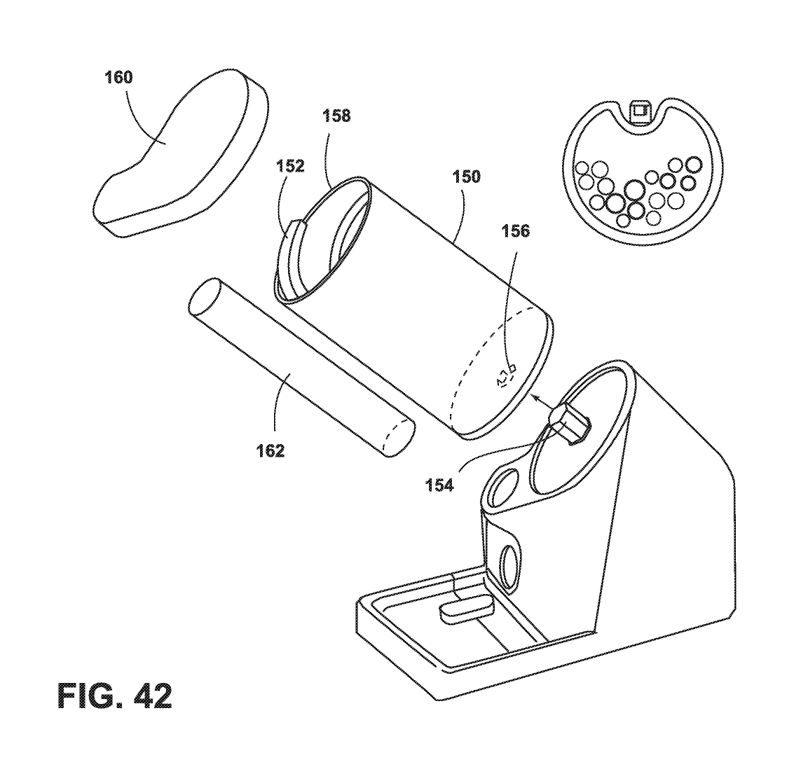

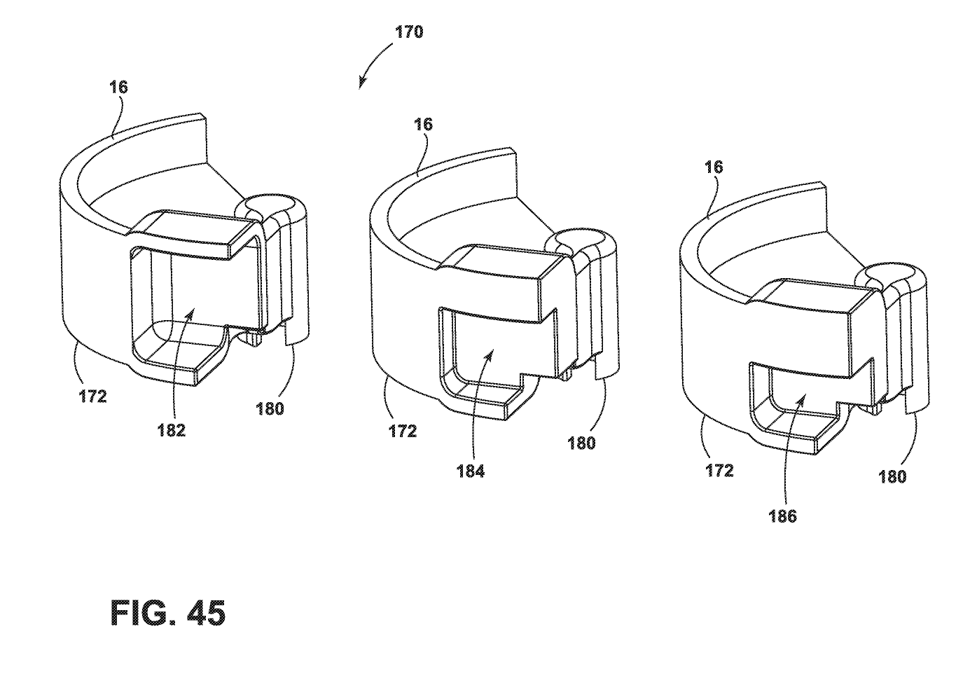

Several embodiments of one aspect of the invention directed to an electro-mechanical screw conveyor pill dispenser are depicted in FIGS. 1-7, 26A-26B, 30-31, 41-42, 45, and 47. FIGS. 1-3 and 41 depict one embodiment a screw conveyor pill dispenser. FIGS. 4-6 and 31 depict a vertically stackable screw conveyor pill dispenser. FIGS. 7, 26A, and 26B depict one embodiment of a horizontally and vertically stackable screw conveyor pill dispenser. FIG. 30 depicts one embodiment of a horizontally stackable screw conveyor for use with a travel pill container. FIG. 42 depicts one embodiment of a screw conveyor pill dispenser with an integrated screw pill container. FIG. 45 illustrates different size scoops for use with a screw conveyor pill dispenser. FIG. 51 illustrates an adjustable scoop for use with a screw conveyor pill dispenser.

The screw conveyor pill dispenser depicted in FIGS. 1-3 and 41 includes a base cover 1, a module cap 2, a screw conveyor 3, a pill container cap 4, a scoop assembly 5, a pill container or hopper 6, a button 7, a dispensing tube 8, and a pill tray 9.

The screw conveyor pill dispenser embodiments may include electrical components. For example, FIG. 46 illustrates a block diagram of electrical components that may be included in any of the screw conveyor pill dispenser embodiments. Specifically, the dispenser may include a control system 1000 that includes a controller 1002, a sensor system 1004, a communication system 1006, an output 1008, an input 1010, a power source or connector 1012, and a motor 1014. The electrical components may be included on a circuit board or connect to the circuit board via wiring.

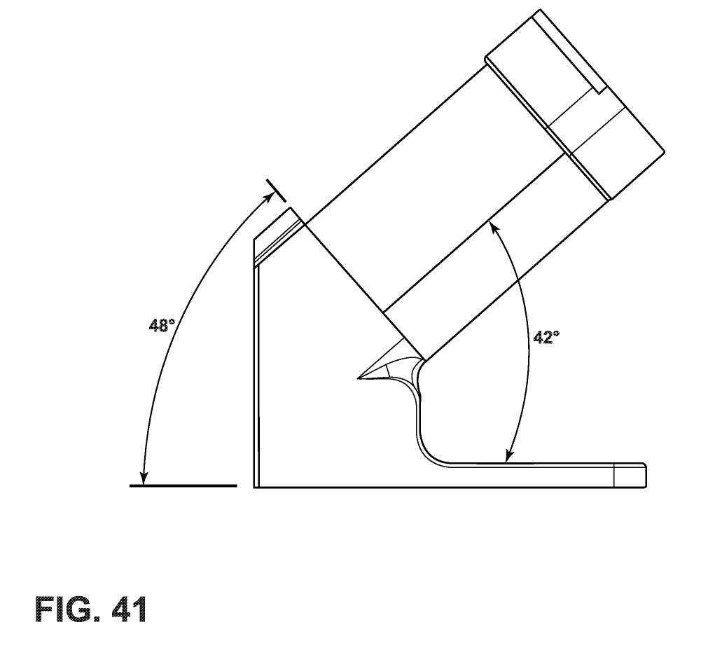

In operation, the screw conveyor pill dispenser or base unit utilizes a DC motor to rotate the screw 3. Due to the angle in which the screw is orientated, one or more pills ride up the side of the pill container on the screw. In the depicted embodiment, the angle of the screw is 42 degrees from the base of the screw conveyor pill dispenser and the angle of the bottom of the pill container to the base unit is 48 degrees, perhaps as best illustrated in FIG. 41. This angle is sufficient to prevent pills from gathering towards the opening in the exit hole and the possibility of dispensing a pill before the scoop assembly scoops one up to dispense. This angle is also sufficient to ensure pills travel up the screw.

As the pill reaches the top of the pill container 6, the scoop assembly 5 scoops the pill and dispenses it out the exit chute 8 through the opening 10 in the pill container 6. If the scoop assembly 5 scoops more than one pill, the angle of the pill container 6 and gravity cause all but one pill to fall back down into the pill container 6. As the scoop assembly 5 rotates about the screw axis 14 and dispenses a pill, the pill exits through opening 10 of the pill container 6 into the dispensing tube 8 where it passes by a sensor 11 (e.g., an optical sensor or photo eye) that recognizes the pill and triggers the motor to stop.

Although the current embodiment utilizes an optical sensor, alternative embodiments may utilize a different type of sensor to determine that a pill has been dispensed.

In one embodiment, the time it takes a pill to exit the pill container 6 and travel down the dispensing tube 8 before passing by the sensor 11 is approximately equal to the time it takes the scoop assembly 5 to pass by the opening 10 in the pill container 6 such that the scoop assembly wall 16 covers the opening 10 in the pill container 6. The scoop assembly wall 16 can cover the opening 10 of the pill container 6 and seal it shut to assist in keeping the pills in the pill container 6 fresh and assist in ensuring the life and efficacy of the pills. In the current embodiment, the motor speed can be selected to be about 45 RPM so that by the time the motor shuts off in response to the dispensing of the pill the scoop assembly wall 16 substantially covers the opening 10 in the pill container 6.

In one embodiment, an oxygen scavenger or oxygen absorber may be included in the pill container in order to help remove or decrease the level of oxygen in the pill container. The oxygen scavenger or absorber may be provided in a packet that can ride up the screw conveyor with the pills, but will not be dispensed due to its size and shape. Movement and circulation of the oxygen scavenger or absorber can increase its effectiveness at removing the oxygen from the pill container resulting in increased efficacy of the pills.

The pill passes by a sensor and dispenses into the pill tray 9. The sensor can communicate that a pill has been dispensed and cause the motor to shut off.

The screw conveyor pill dispenser can be stacked vertically, horizontally, or vertically and horizontally with additional screw conveyor pill dispenser modules. FIGS. 4-6 illustrate one embodiment of a vertically stacked screw conveyor pill dispenser. FIG. 30 illustrates one embodiment of a horizontally stacked screw conveyor pill dispenser. FIGS. 7, 26A, and 26B illustrate one embodiment of a screw conveyor pill dispenser that is horizontally and vertically stacked.

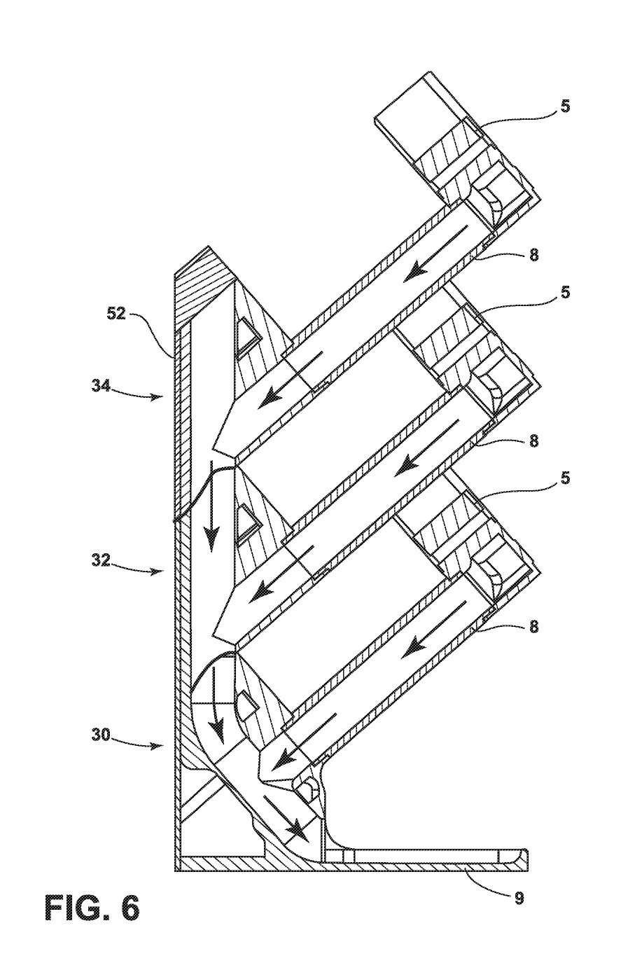

The stacked embodiments each include one or more base screw conveyor pill dispensers and one or more screw conveyor pill dispenser modules. The base screw conveyor pill dispenser includes generally the same components as described above in connection with the screw conveyor pill dispenser of FIGS. 1-3. In some embodiments, the screw conveyor pill dispenser modules and base unit form a dispensing chute 52 that can direct pills from the dispensing tubes 8 to the pill dispenser tray 9. Perhaps as best shown in FIG. 6, a pill can travel down a dispensing tube 8 into a base 30 or module 32, 34. Each module 32, 34, lines up to the next for a smooth transition to the next module. Each module and base assembly may include a photo eye or other sensor to recognize that a pill has passed, which allows the scoop assembly 5 of each module and base to seal its respective pill container.

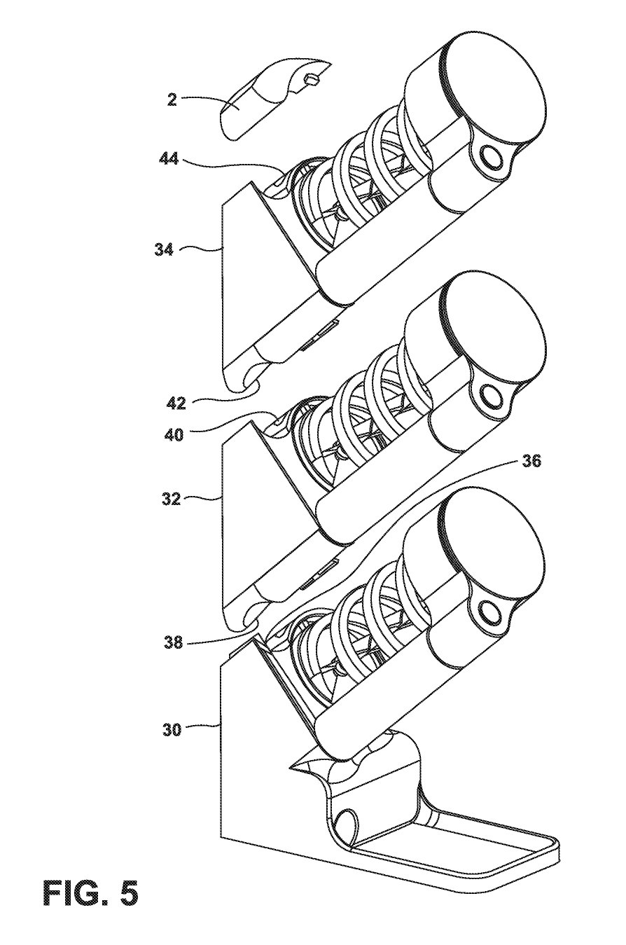

Each module may include its own power source or alternatively, the modules can be configured to transfer power from one module to the next. In this way, the entire assembly can be powered by one power connector or source in a base unit. In order to facilitate this configuration, the base screw conveyor pill dispenser and the module screw conveyor pill dispensers may include contacts for transferring power and/or communication between modules or between the base and a module. Perhaps as best shown in FIG. 5, a first module 32 can be stacked on top of the base 30 such that the bottom set of contacts 38 on the module 32 contact the set of contacts 36 on the base 30 and allow power, communication, or power and communication to pass between the base and the module. In a similar fashion, the bottom set of contacts 42 on a second module can contact the top set of contacts 40 on the first module to allow power, communication, or power and communication to pass between the first module and the second module. The cap 2 may cover the top set of contacts 44 on the second module. Although two modules are depicted, in alternative embodiments, additional modules may be stacked on top of the second module.

Vertically stacked pill dispensers can also be stacked horizontally as depicted in FIGS. 7, 26A, and 26B. In the depicted embodiment, the base units may include electrical contacts 2600 or wireless power coils on both sides such that base units can be set adjacent to each other and transfer power and/or communication.

FIG. 30A depicts one embodiment where several screw conveyor dispensers are stacked horizontally with a flat pill tray 9 to accommodate a travel pill container. In operation the travel pill container can be slid on the flat pill tray 9 surfaces to position the dispensing tube 8 exit for one of the travel pill containers. The travel pill container can be slid horizontally with respect to the dispensing tube 8 exit so that entire week's pills can be dispensed easily into the pill container. In this way, a travel pill container can be filled conveniently.

FIG. 30B shows an electro-mechanical screw conveyor pill dispenser that is expanded horizontally with the addition of a travel pill tray. Each day of the travel tray could be separated from the full week tray. The single tray section for a specific day can be slid into the base to capture the pills being dispensed from the hopper. The single day tray can have a lid that slides to open the compartment of that tray. Also, while the single day tray is sliding into the base to capture the pills it can also push back and hide a base travel tray cover.

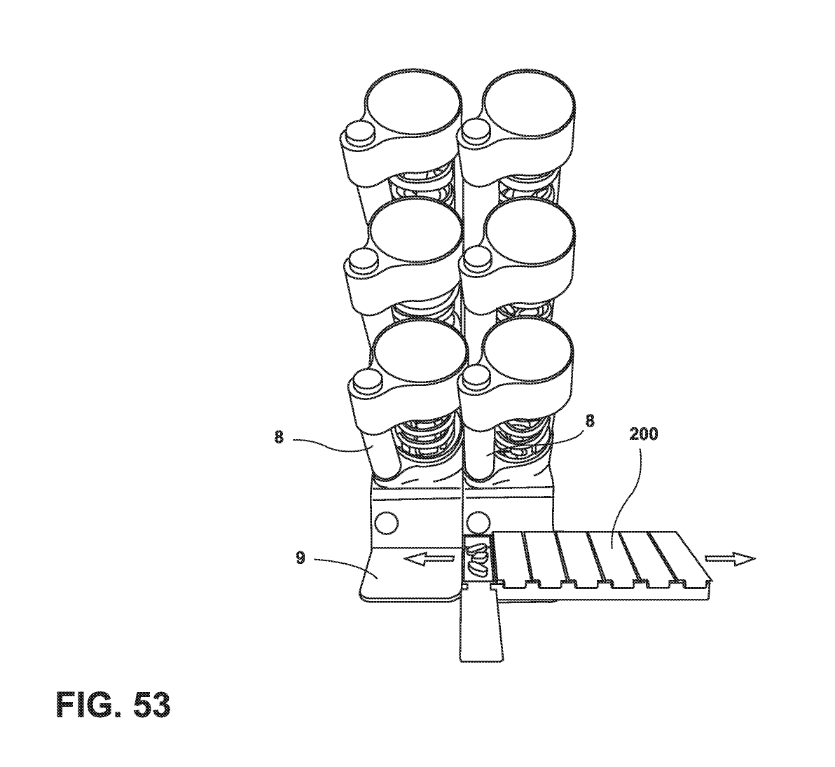

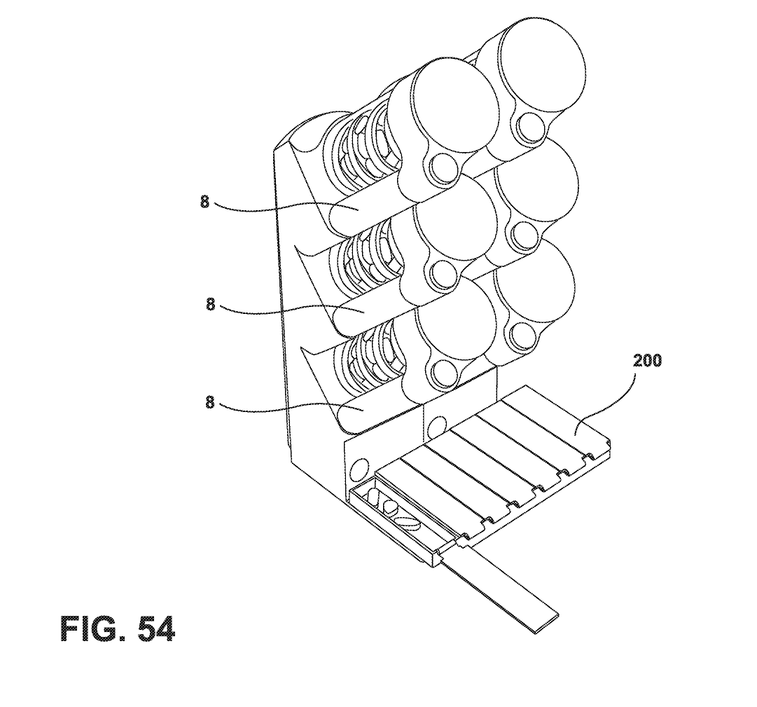

Referring now to FIGS. 53-54, several screw conveyor dispensers are stacked horizontally and vertically with a flat pill tray 9 to accommodate an embodiment of a travel pill container 200. The travel pill container 200 can be slid horizontally with respect to the dispensing tube 8 exit so that entire week's pills can be dispensed easily into the travel pill container 200. The travel pill container 200 can have multiple single day pill containers with lids that can slide open such that the appropriate daily pills can be dispensed into the daily pill containers.

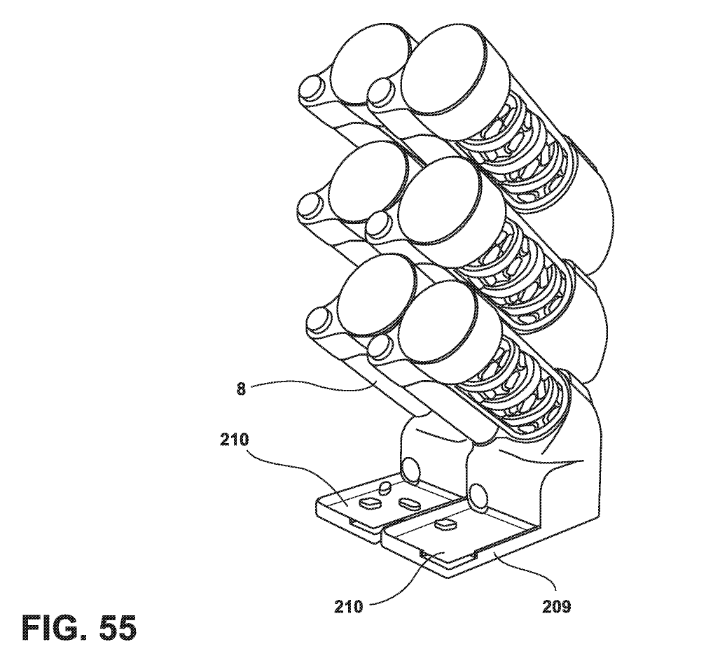

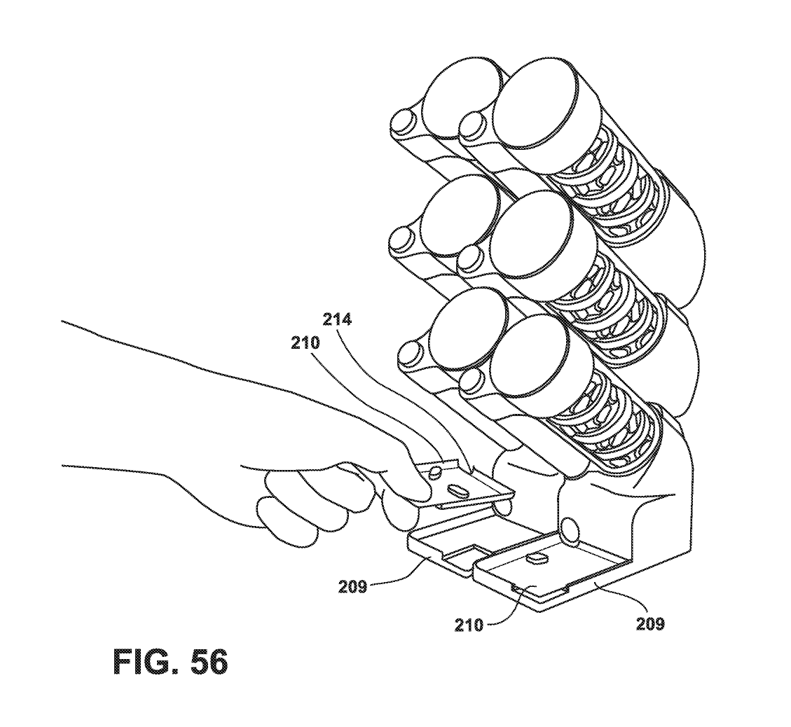

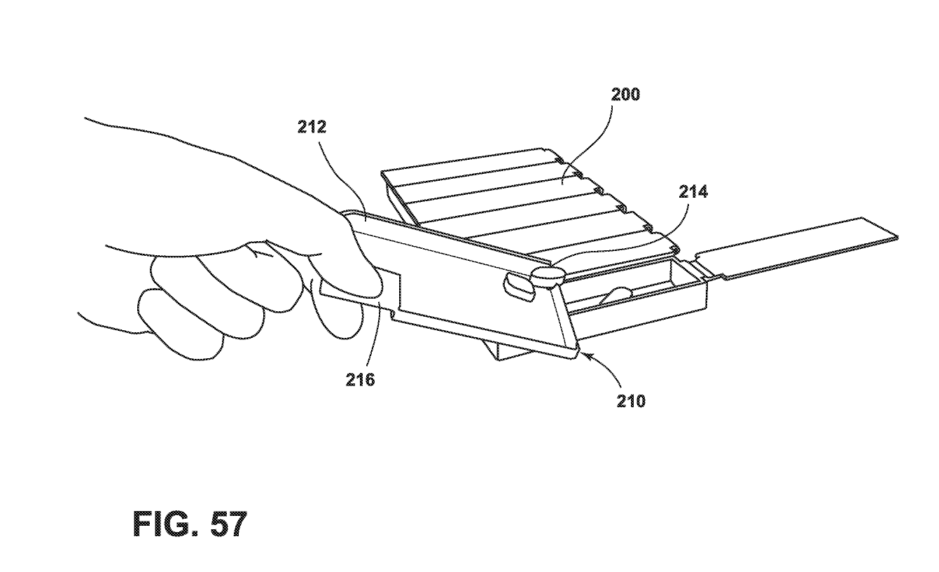

FIGS. 55-57 show another embodiment of a flat pill tray 209 that includes a removable tray 210. The removable tray 210 includes a lip 212 that extends substantially around the perimeter thereof. The removable tray 210 also includes a notch 214 through the lip 212 and a raised handle 216 portion. Pills that have been dispensed from the hopper land on the removable tray 210, which then can be removed using the handle 216. The lip 212 keeps the pills from spilling off the removable tray 210, yet the pills can be poured into the travel pill containers through the notch 214.

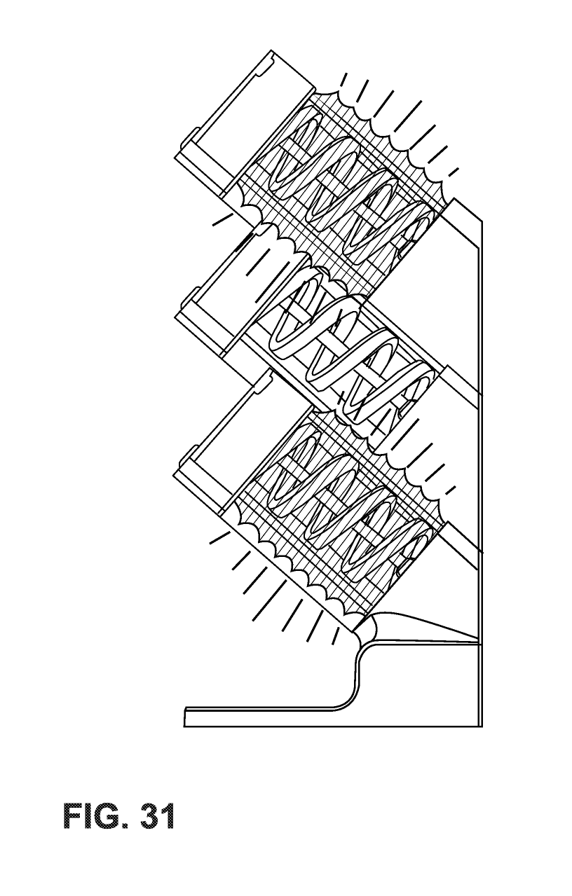

FIG. 31 shows that each pill dispenser can light up using LEDs. As will be discussed in more detail below, each module can individually indicate which pills are ready to be taken or indicate when pills have not been taken for an extended period of time.

In some embodiments, the screw conveyor can be integrated with the pill container. For example, as shown in FIG. 42, the pill container 150 can be molded with the screw windings 152 along the inner surface of the container. In the depicted embodiment, the bottom of the pill container 150 interfits or locks with the screw axel 154 such that when the motor (not shown) drives the screw axel 154 the entire pill container and therefore the screw windings 152 rotate. In the depicted embodiment, the pill container 150 includes a molded keyed socket or threaded drive 156 that locks on the molded keyed bottom 154.

In contrast to the FIGS. 1-3 embodiment where the pill container remains stationary as the screw conveyor turns, in this embodiment the entire pill container rotates with the integrated screw windings. In this embodiment, similar to the FIGS. 1-3 embodiment, as the internal helical pill guide or screw windings rotate pills ride up the screw windings along the edge of the pill container until they reach the top of the pill container.

The pill container 150 may include threads or a snap ring 158 for interfacing with a pill container cover 160. The FIG. 42 embodiment may include a scoop assembly for dispensing pills into the dispensing tube 162 as they reach the top of the pill container as discussed above in connection with other embodiments.

FIG. 45 illustrates one embodiment of an adjustable scoop assembly. In the FIG. 45 embodiment, the adjustable scoop assembly 170 includes three different size scoop assemblies that can be selectively installed on the end of the screw conveyor axel. The first scoop assembly 172 includes a scoop 182 sized to scoop up large pills, the second scoop assembly 174 includes a scoop 184 sized to scoop up medium sized pills, and the third scoop assembly 176 includes a scoop 186 sized to scoop up small pills. In the depicted embodiment, all three scoop assemblies include a scoop assembly wall 16 for sealing the pill container after a pill is dispensed. Further, all three scoop assemblies include a socket for interfacing with the screw conveyor axel such that when the screw conveyor axel is rotated, the scoop assembly rotates.

Another embodiment of an adjustable scoop assembly is illustrated in FIG. 51. In this embodiment, the size of the scoop of the scoop assembly is adjustable. The depicted adjustable scoop includes a socket portion sized to fit over the screw conveyor axel such that rotation of the screw conveyor axel results in ration of the adjustable scoop assembly. The adjustable scoop assembly includes a movable arm 2002 that can slide through an opening 2004 in the scoop 2004 to adjust the size or shape of article that the scoop can receive.

II. Tumbler Dispenser

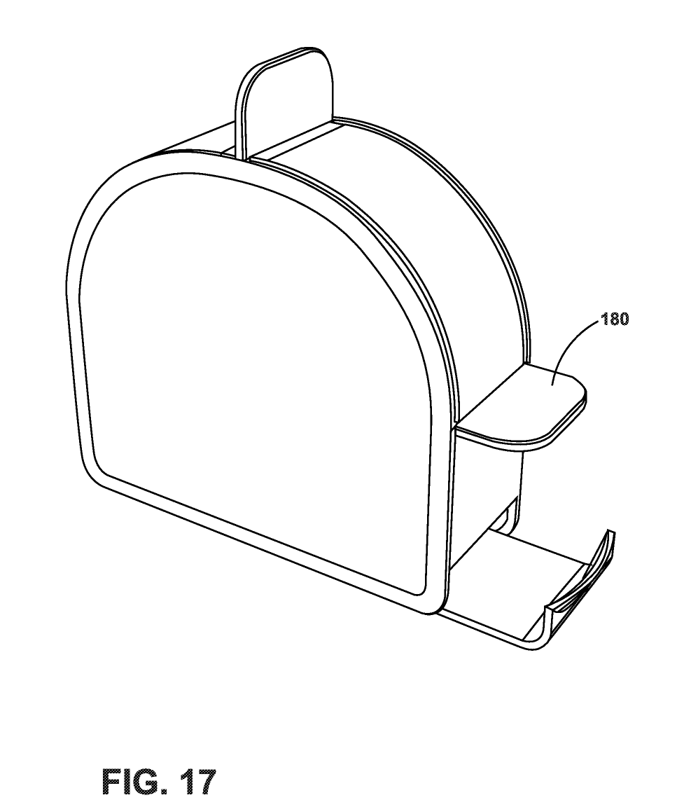

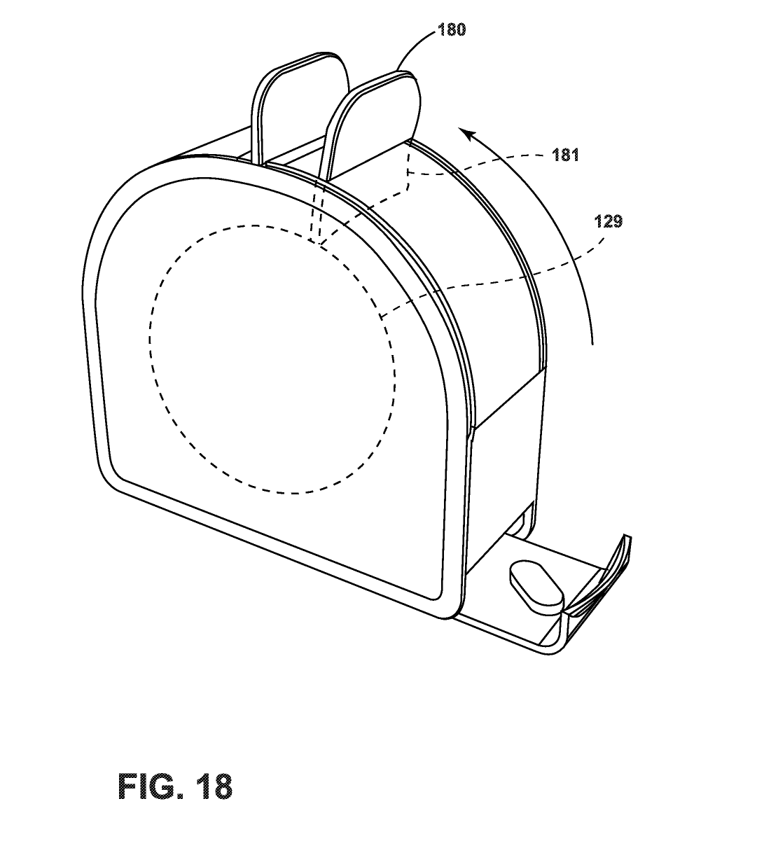

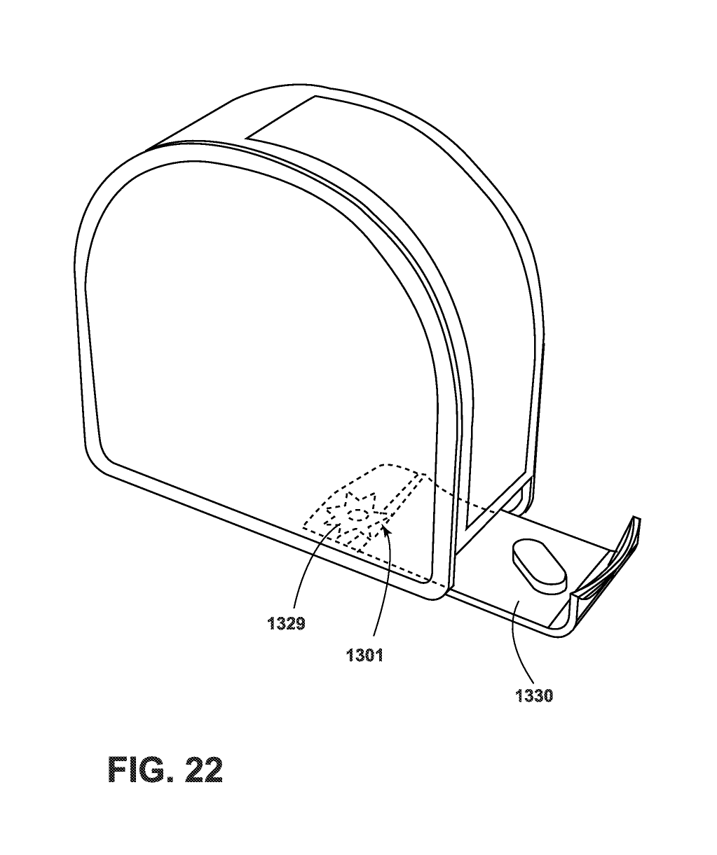

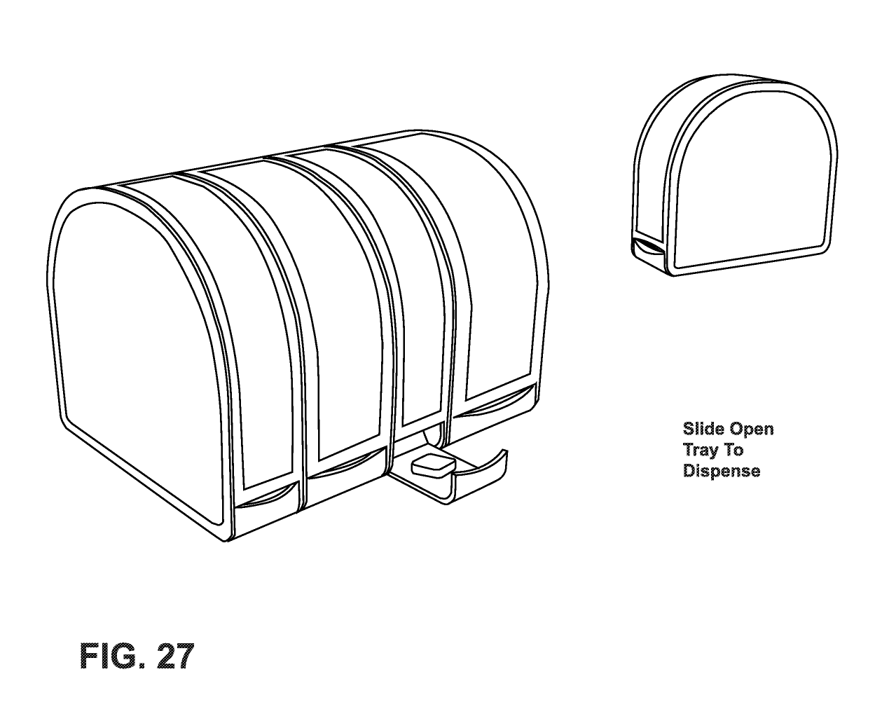

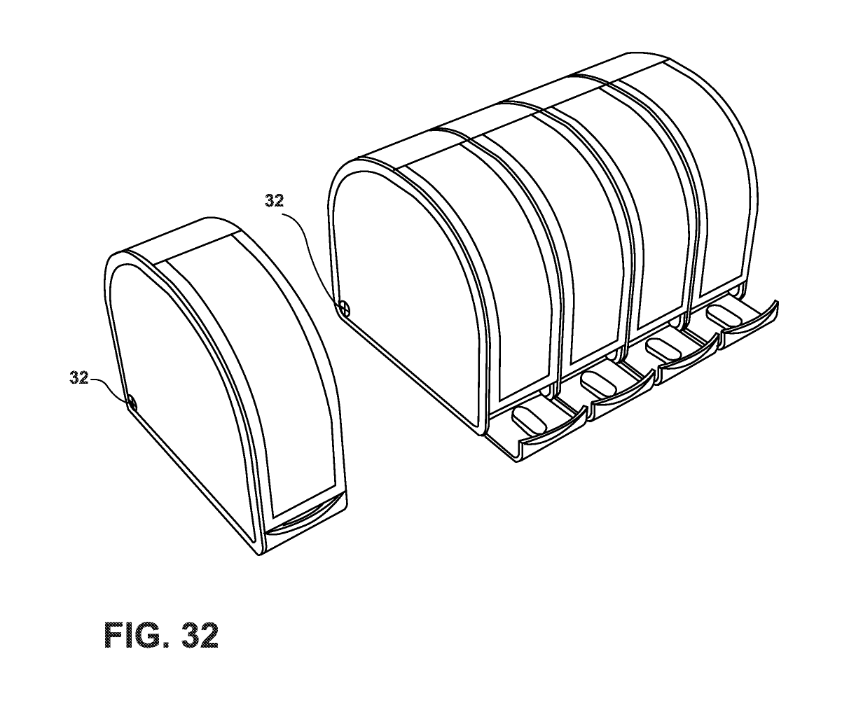

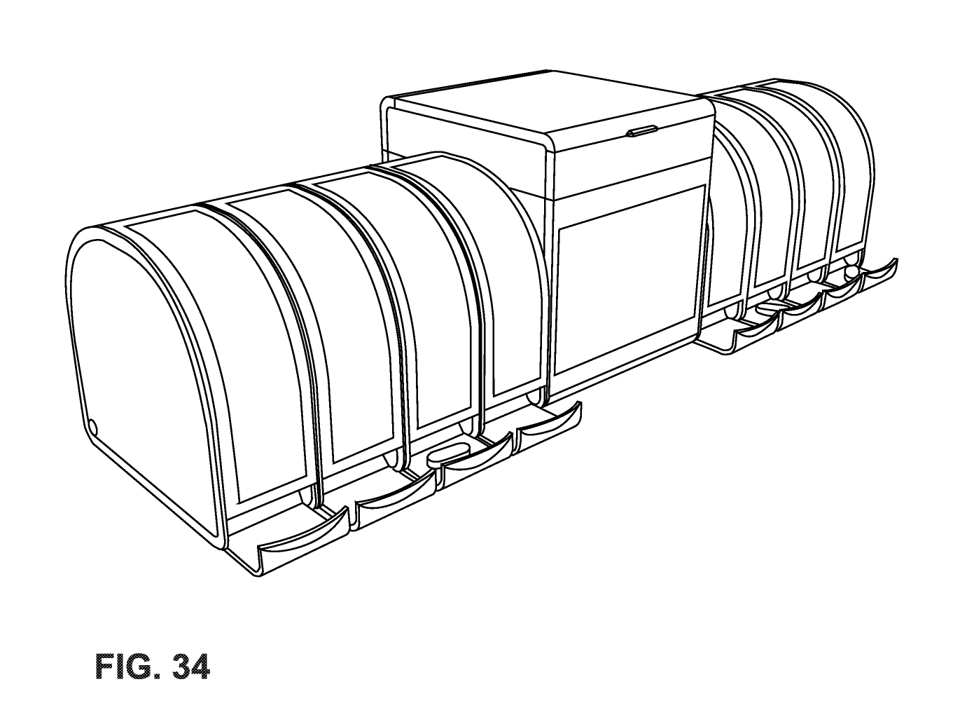

Several embodiments of one aspect of the invention directed to a mechanical or electro-mechanical tumbler pill dispenser are depicted in FIGS. 17-22, 27, and 32-36. FIGS. 17-18 depict one embodiment of a mechanical tumbler pill dispenser. FIG. 22 depicts another embodiment of a mechanical tumbler pill dispenser. FIGS. 19-21, and 33 depict an electro-mechanical tumbler pill dispenser. FIGS. 27 and 32 depict one embodiment of a horizontally expandable tumbler pill dispenser. FIG. 34-36 depict another embodiment of a horizontally expandable tumbler pill dispenser.

FIG. 19 illustrates an electro-mechanical tumbler pill dispenser with the tray 130 closed. The pill dispenser housing lid 23 and the main housing 27 may include labels. The electro-mechanical tumbler pill dispenser can dispense pills automatically or semi-automatically. In an automatic embodiment, the tumbler pill dispenser may include a control system capable of communicating with a device and dispensing pills upon proximity detection. In a semi-automatic embodiment, the tumbler pill dispenser may include a control system capable of communicating with a device and dispense pills upon instructions from a device or may include a button or other actuator that operates the motor to dispense one or more pills in response to activation.

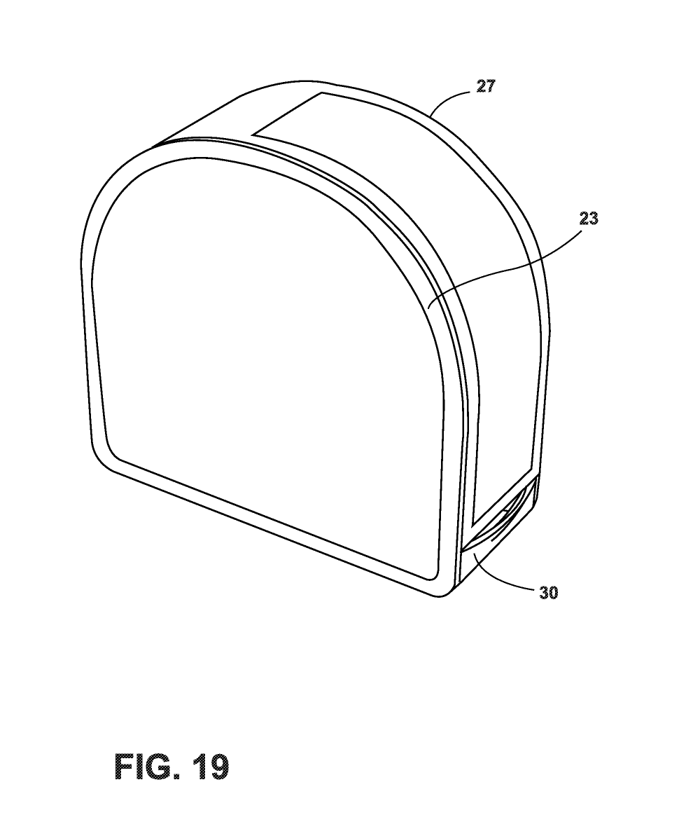

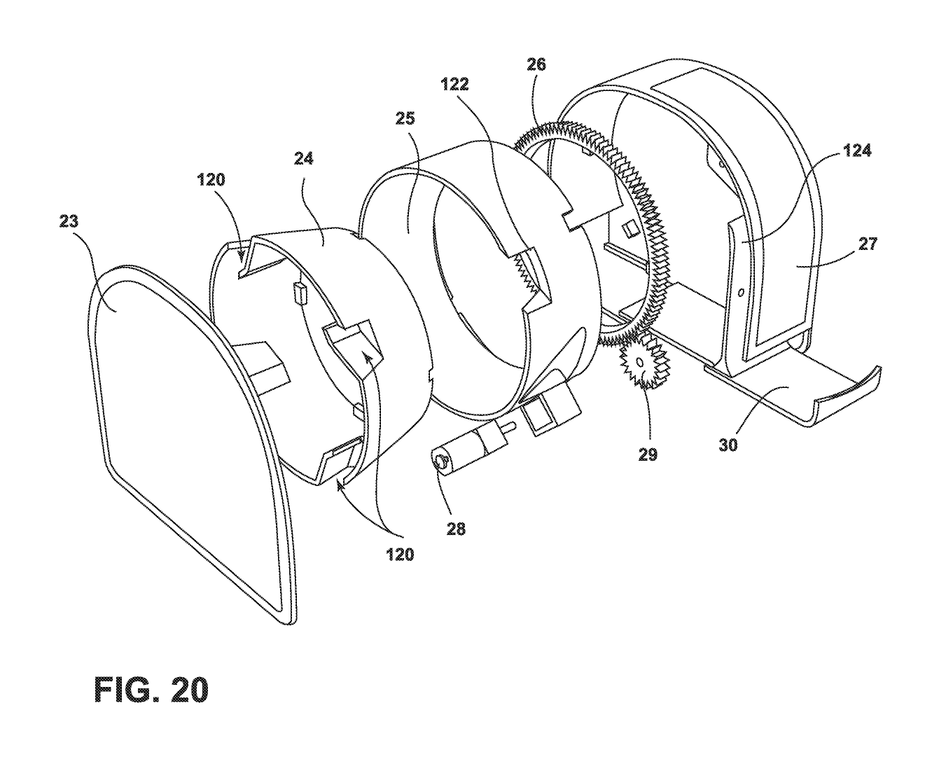

Perhaps as best shown in the exploded view of FIG. 20, the electro-mechanical tumbler pill dispenser includes a housing lid 23, a pill container 24 with one or more pockets 120, a shroud 25 including an opening 122, a large gear 26, a main housing 27 with a dispensing conduit 124, an electric motor 28, a small gear 29, and a movable tray 30. The lid 23 can snap on to the main housing 27 capturing the pills and internal components of the tumbler pill dispenser. The pill container or dish 24 may contain a plurality of pills and can be rotated in order to dispense one or more pills. The shroud 25 can restrict pills from dispensing until the pill container 24 is rotated to an ejecting location. The larger gear interfaces with the pill container 24 and a smaller gear 29 that is rotated by an electric motor 28. The tray 30 can slide to open and close. The main housing 27 may include a photo eye or other sensor to identify a pill has been dispensed.

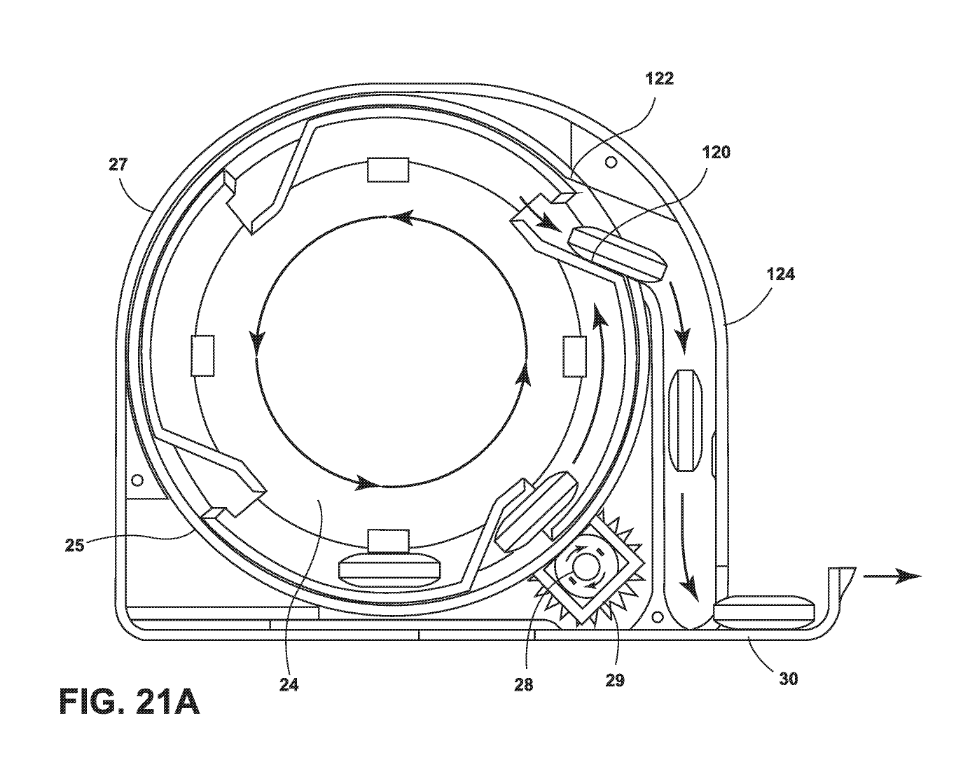

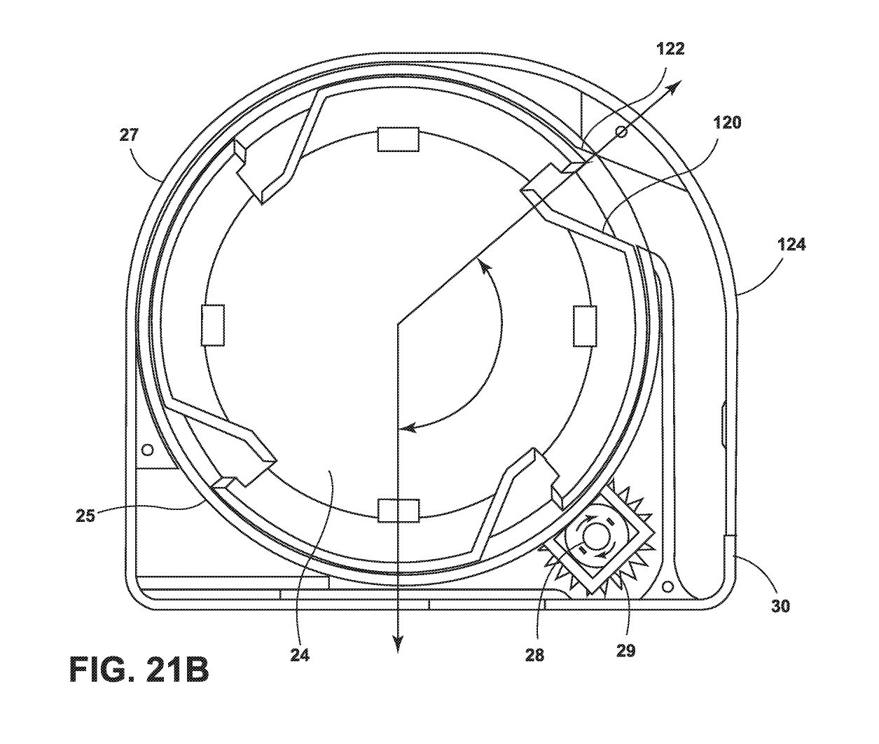

FIG. 21A shows how one embodiment of an electro-mechanical tumbler pill dispenser functions. In operation, the motor 28 rotates the small gear 29, which in turn rotates the large gear 26, which is fixed to the pill container 24, causing the pill container 24 to rotate. In the depicted embodiment, the rotation of the pill container 24 is counter-clockwise as shown in FIG. 21A. As pill container 24 rotates, pills in the pill container tumble and eventually one or more pills nests into pocket 120. The pocket 120 can be sized to fit a specific size and shape pill or pills. For example, in the depicted embodiment, the pocket 120 is sized to fit a single pill. In alternative embodiments, the pocket can be sized to fit two or more pills, commensurate with a desired dosage for that type of pill. As the pill container 24 rotates, the pill in the pocket 120 slides down the pocket resting against the shroud wall 25. As the pill container 24 rotates and the opening 122 in the shroud 25 aligns with the pocket 120, gravity assists the pill in sliding down the surface of the pill container pocket 120 through the opening 122 of the shroud 25 and through the dispensing conduit 124 to the dispensing tray 30. The angle of the opening 122 of the shroud 25 is illustrated in FIG. 21B. In the current embodiment this 131 degree angle was selected for providing a desired movement of the pill from the pocket 120 through the opening 122 of the shroud. In alternative embodiments, a different angle, larger or smaller, may be selected.

The tumbler pill dispenser can be mechanically operated instead of being operated by a motor. FIGS. 17-18 illustrate a mechanical tumbler pill dispenser embodiment with a finger operated trigger 180 to dispense. The trigger 180 is mechanically coupled to gear 129 by way of catch 181 such that movement of the trigger 180 results in rotation of gear 29 and ultimately dispenses a pill, similar to how rotation of gear 29 in the electro-mechanical embodiment results in dispensing of a pill. The trigger 180 can rotate depending on how many ejecting locations or pockets 120 are present. 360 degrees divided by the amount of ejection locations can determine the degree of rotation. In an alternative mechanical tumbler pill dispenser embodiment illustrated in FIG. 22, the tray 1330 is mechanically coupled to the small gear 1329, such that sliding of the tray 1330 rotates the gear 1329 and ultimately dispense a pill, similar to how rotation of gear 1329 in the electro-mechanical embodiment. The mechanical coupling can be accomplished with a catch 1301 on the tray 1330 that pulls on the small gear 1329 inside of the pill dispenser and manually rotates the gear.

In one embodiment, the tumbler pill dispenser can be expanded horizontally as illustrated in FIGS. 27 and 32. FIGS. 27 and 32 show how multiple pill dispensers can attach and interface with each other. For example, the pill dispensers may include physical or magnetic couplers for aligning the tumbler pill dispensers.

In the depicted embodiment, the pill dispensers share the same profile shape but are sized for different depths in order to fit smaller/larger quantity/size pills. That is, a plurality of tumbler pill dispensers can be arranged horizontally to accommodate a variety of different types or sizes of pills. Further, the pill container or drum may be sold separately in disposable containers that can be inserted into the tumbler pill dispenser. The pill container for use in a tumbler pill dispenser can be heat, shrink, vacuum, or otherwise sealed in order to improve the life and efficacy of the pills.

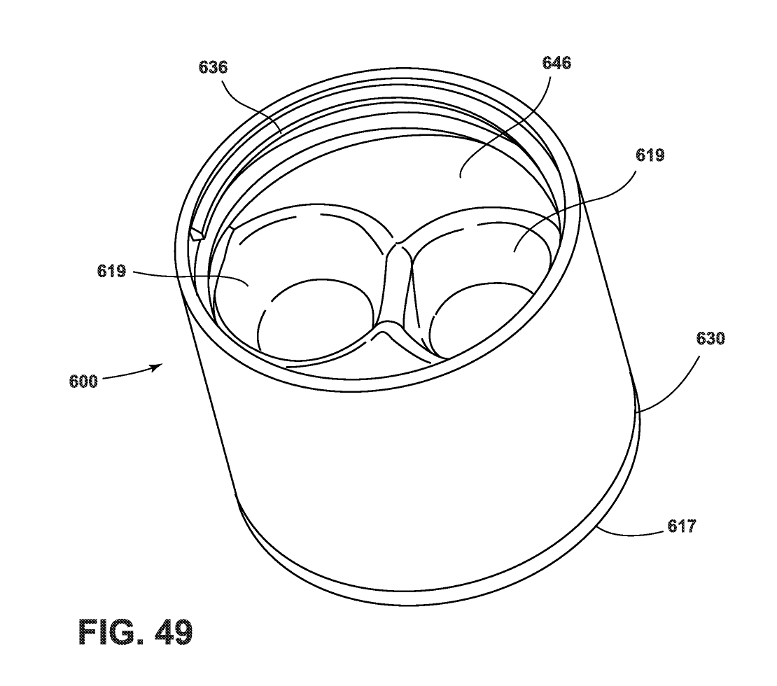

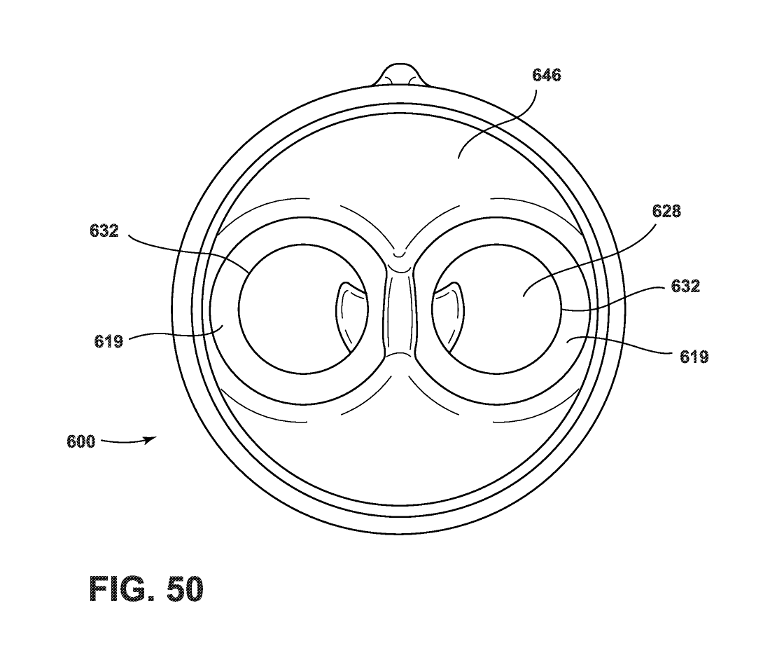

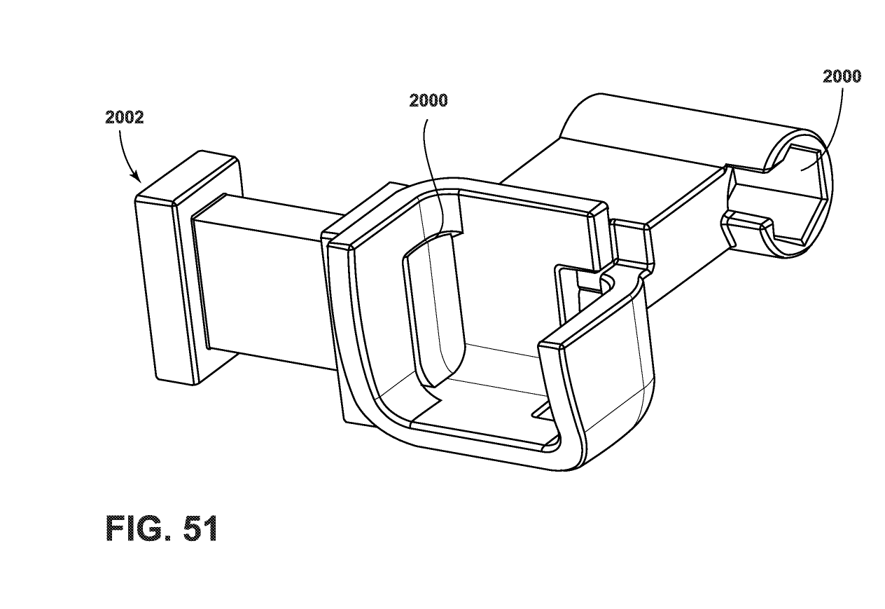

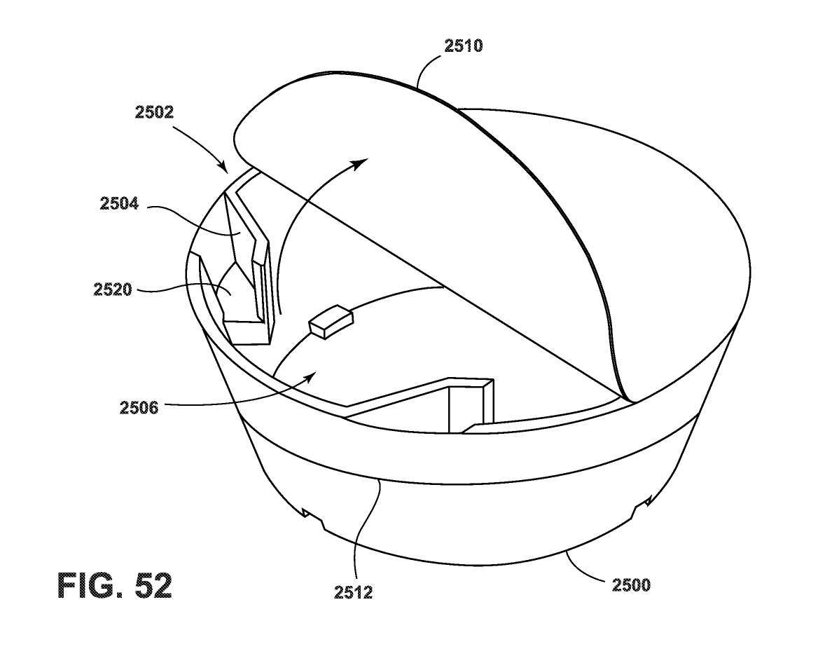

In one embodiment, as shown in FIG. 52, the pill container 2500 is removably sealed by way of a seal 2502. In the depicted embodiment, the removable seal 2502 covers the ejecting locations 2504 where the pockets 2520 are located and also covers the container opening 2506. In the depicted embodiment, the removable seal 2502 is a two part seal where a first portion 2510 of the seal removably seals the opening 2506 on the top of the container 2500 and another portion 2512 of the seal removably seals the ejecting locations 2504. The two part seal enables the container to be used as a conventional pill container or a container for use with a tumbler pill dispenser. By removing the first portion 2510 of the seal, a user can gain access to the pill container in a traditional manner. Alternatively, the second portion of the seal 2512 or first and second portions of the seal 2512 can be removed so that the container 2500 can be installed in a pill dispenser tumbler. In this way, the container 2500 can be utilized as a conventional pill container or as a pill container for a tumbler pill dispenser.

In alternative embodiments, the removable seal 2502 may be a one piece seal that seals both the opening 2506 of the container and the ejecting locations 2504. In yet another embodiment, the container may not include an opening 2506 (e.g. the container 2500 may include a secured or integral lid covering the top of the pill container) and the container may be removably sealed by a seal that covers the ejecting locations 2504. The seal can be tape or another removable seal as shown in FIG. 52 as seal 2512. The pill dispenser pockets can be sized for a particular pill or pill size, but interact with a generic tumbler pill dispenser shroud, housing, and motor. A travel tray can be stored on a center module, ready for use.

The tumbler pill dispensers of FIGS. 27 and 32 can be mechanical or electro-mechanical. FIG. 32 shows how the pill dispensers can interface with each other, by stacking alongside each other and have electrical contacts 32 that serve as a connection point to share electrical power and data between units. In an electro-mechanical embodiment, the tumbler pill dispensers may each include a power source or power connector and a motor. Alternatively, the tumbler pill dispensers may include electrical contacts 32 or wireless power units for transferring power and/or communication between the tumbler pill dispensers. The electrical contacts 32 may be included on one or both sides of the tumbler pill dispensers.

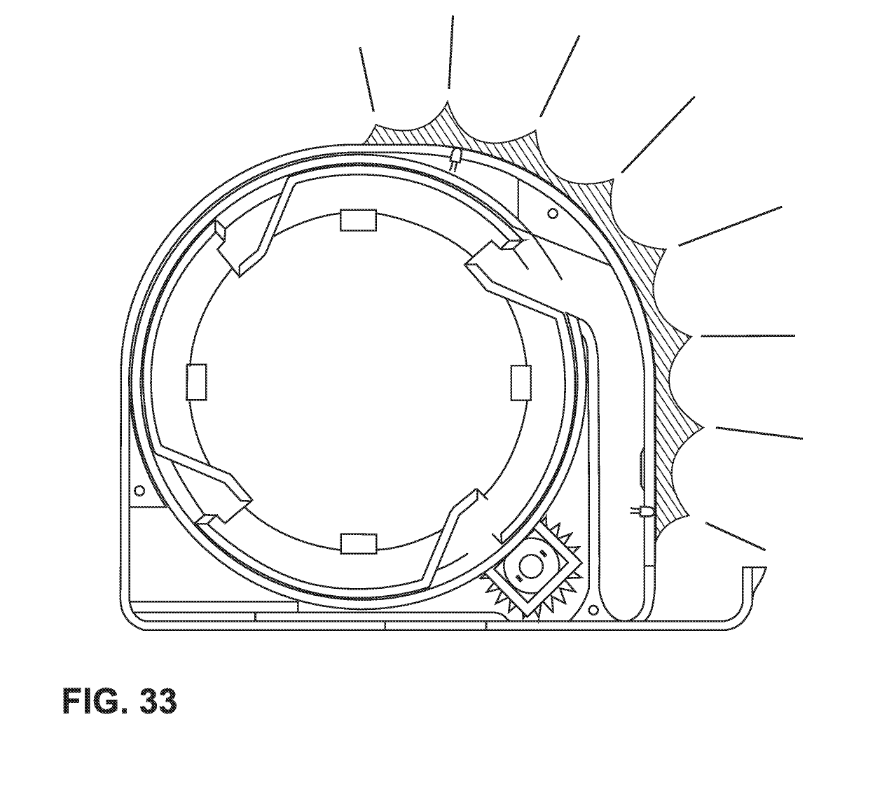

FIG. 33 illustrates how the front edge of the tumbler pill dispenser can be lit via LEDs 33 and light pipe on the edge to let the consumer know what pill to dispense/consume. The functionality of the lighting will be discussed in more detail below in connection with the control systems.

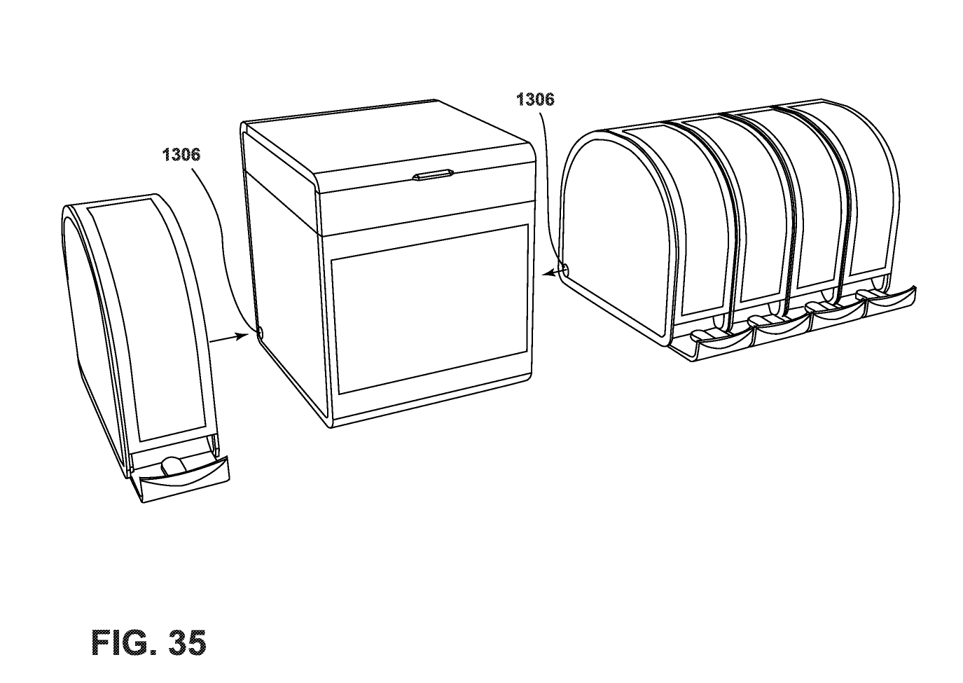

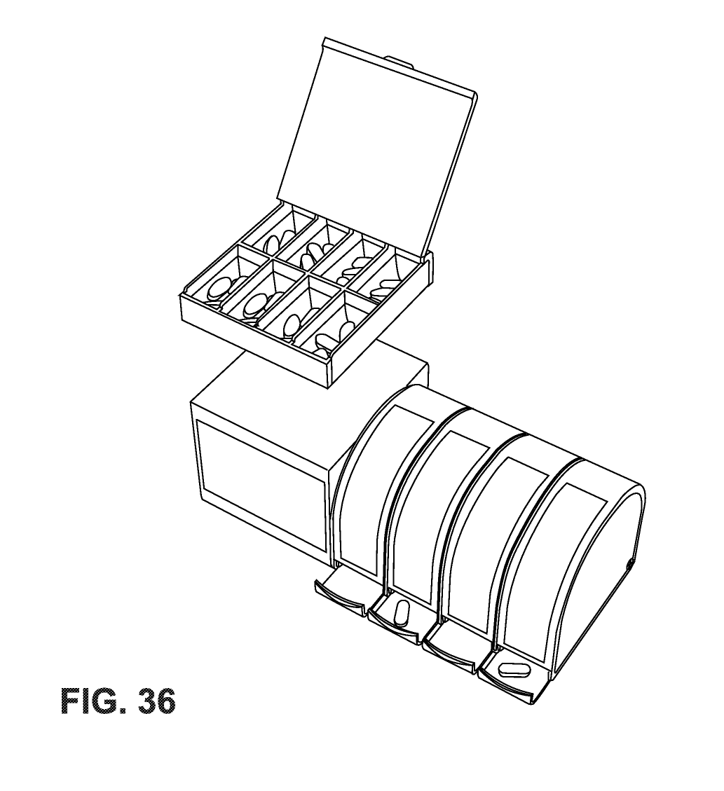

FIGS. 34-36 illustrate a plurality of tumbler pill dispensers 1300 interfacing with a master unit 1302. The tumbler pill dispensers 1300 can stack on either side of the master unit 1302. The master unit may include a power supply or connection to a power source and can pass power to the pill dispensers 1300 via electrical contacts or wirelessly. The master unit 1302 can include a touch screen 1304 and memory for storing data such as inventory, reminders, reordering and consumer profiles. The master unit may be capable of interfacing with the tumbler pill dispensers 1300 or with other devices via Wi-Fi or Bluetooth. FIG. 35 shows one embodiment where the master unit 1302 interfaces with the slave pill dispenser containers via electrical contacts 1306. The electrical contacts 1306 on the pill dispensers 1300 and the master unit 1302 can transfer power via electrical contacts and can include magnets or other connectors to lock the pill dispensers in place. FIG. 36 illustrates a travel case stacked on top of the master unit. Pills dispensed from the tumbler dispensers can be conveniently moved to the travel case.

III. Push-to-Operate Dispenser

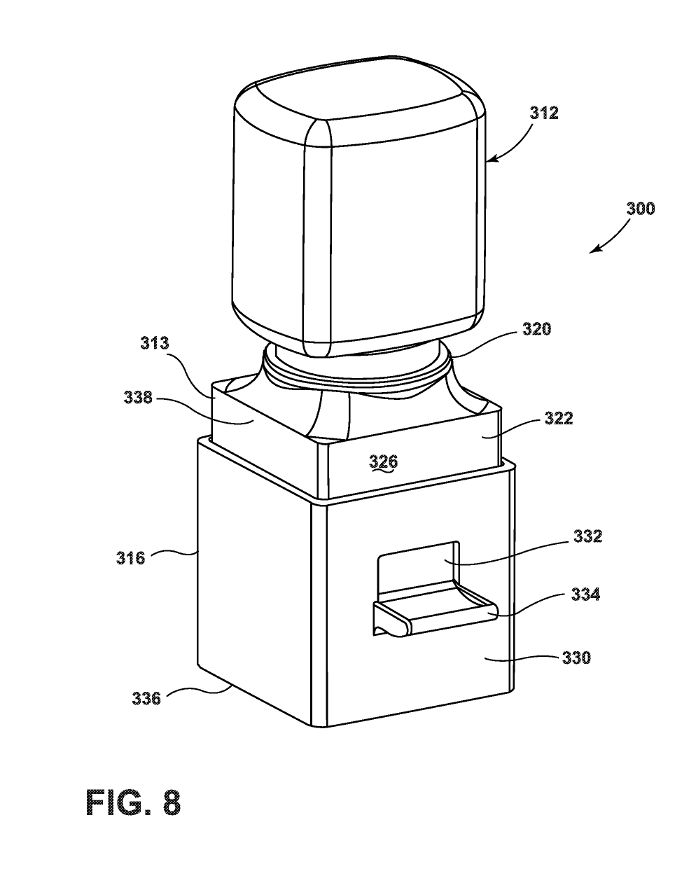

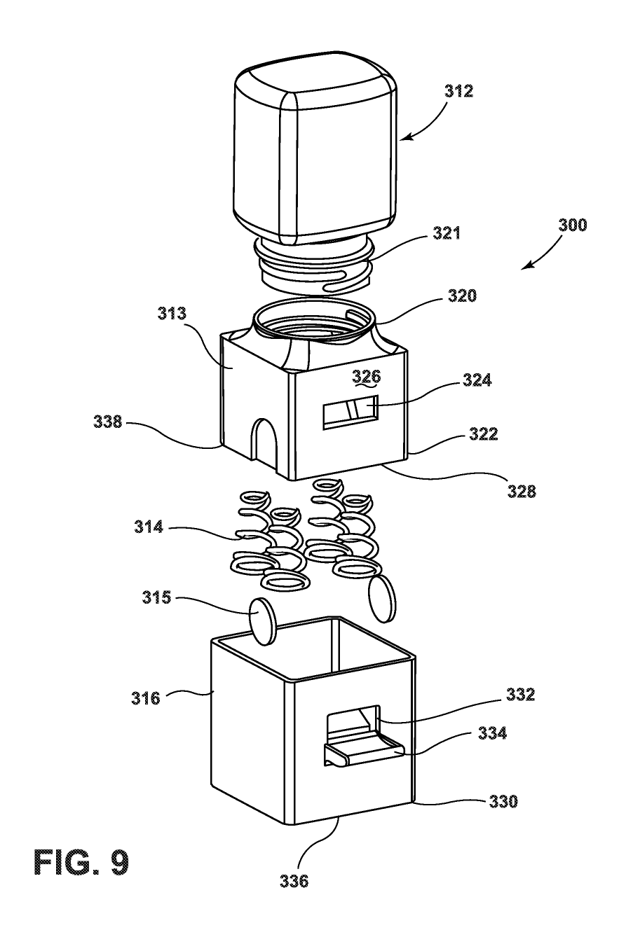

A pill dispenser in accordance with one aspect of the present invention is shown in FIGS. 8 and 9 and generally designated 300. The pill dispenser 300 is for use with a conventional pill bottle 312 and, generally speaking, is a push-to-operate type pill dispenser. The pill bottle 312 is standard and may contain a large number of capsules, tablets, pills, etc., collectively referred to herein as “pills.” Though the bottle 312 may contain many pills, the pill dispenser 300 is configured to dispense one pill at a time.

The pill dispenser 300 generally includes an inner shell or housing 313, an outer shell or housing 316, and one or more springs 314 enclosed within the inner and outer housings 313 and 316. The inner housing 313 is a substantially box-shaped member that includes a threaded neck 320 that can be releasably screwed onto an externally threaded, standard-sized mouth 321 of the pill bottle 312. A side wall 322 of the inner housing 313 includes a window 324 communicating with the neck 320 via a substantially funnel-shaped interior chamber 326 of the inner housing 313.

The inner housing 313 also includes a lower surface 328 that closes off the lower portion of the inner housing 313. One or more springs 314 are mounted or affixed to the exterior side of the lower surface 328. In the exemplary embodiment, the pill dispenser 300 is illustrated using four springs 314; however, it should be easily understood that more or fewer springs could be used. The lower surface 328 may have an opening (not shown) therethrough, the purpose of which will be described hereinafter.

The outer housing 316 is a substantially box-shaped member sized to receive the inner housing 313 therewithin. A side wall 330 of the outer housing 316 includes a dispenser window 332 and a presentation ledge 334 positioned just below the dispenser window 332. A guide post (not shown) extends upwardly from a base 336 of the outer housing 316 and is positioned within the interior of outer housing 316.

When the components of the pill dispenser 300 are assembled, the one or more springs 314 are bounded by the lower surface 328 of the inner housing 313 and the base 336 of the outer housing 316. Further, although not shown, the guide post of the outer housing 316 extends through the opening in the lower surface 328 of the inner housing 313.

In use, the pill dispenser 300 is screwed onto the mouth 321 of the pill bottle 312. The pill bottle 312 is then inverted and the pill dispenser 300 may be set on its base 336 onto a support surface, such as a table or shelf, with the inverted pill bottle 312 extending up from the pill dispenser 300. In this original position, the pills will fall into the interior 326 of the pill dispenser 300. To dispense a pill, a user simply depresses the pill bottle 312 while it is sitting on its base 336 on the support surface. Depressing the pill bottle 312 of pushes the inner housing 313 down into the outer housing 316, compressing the enclosed one or more springs 314. When the inner housing 313 is depressed to a predetermined position, the window 324 of the inner housing 313 and the dispenser window 332 of the outer housing 316 are aligned such that a pill can fall through the windows 324 and 332 and onto the ledge 334, accessible through the side wall 330 of the outer housing 316 to the user. The guide post (not shown) may include an angled upper surface such that it encourages pills to fall into and through the windows 324 and 332. Further, the funnel-shaped interior 326 of the inner housing 313 and the angled surface of the guide post both work to guide the pills through the aligned windows 324 and 332. Once the pill has been dispensed, the user can release the pill bottle 312, and the compressed one or more springs 314 will return the inner housing 313 to the original position. In the original position, the windows 324 and 332 are not aligned, thereby preventing pills from being dispensed. The pill dispenser 300 could be provided as a retrofit cap to existing bottles and containers, or could be provided in the sale of the pills.

Though the pill dispenser 300 is shown as having a rectangular geometric shape, other suitable shapes, such as circular, are also contemplated. Further, Applicants have found that proper sizing of the windows 324 and 332 helps with proper dispensing of the pills. For example, the windows 324 and 332 may be sized to be substantially 110% to 150% of the size of the intended pill. Accordingly, it is contemplated that the overall size of the pill dispenser 300 and the dimensions of the features thereof can be scaled up or down, relative to the size of the particular pill, tablet, capsule, etc. intended to be used with the pill dispenser 300.

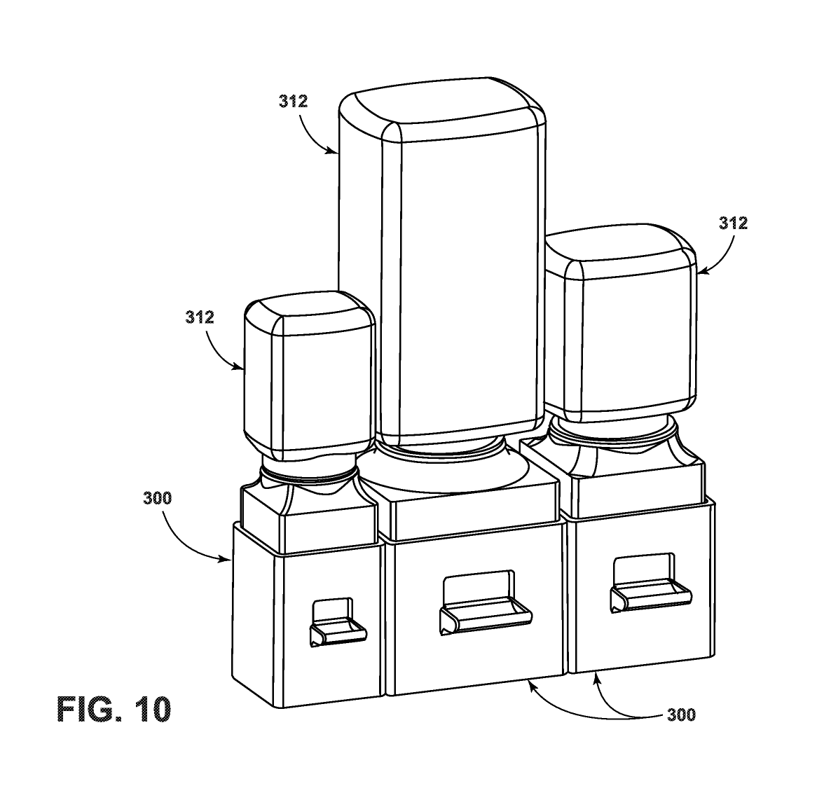

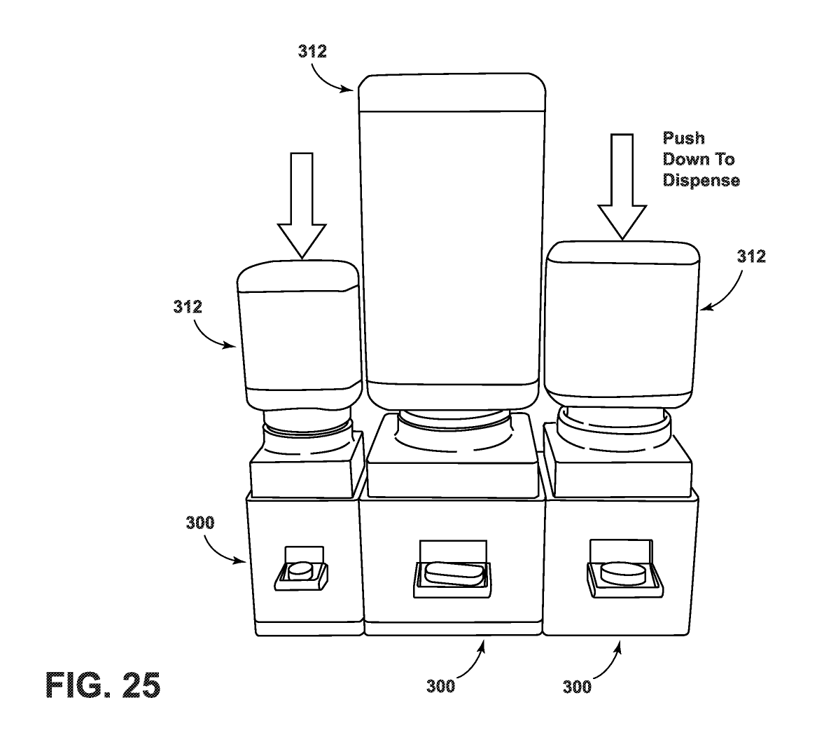

Referring now to FIGS. 9, 10 and 25, according to another embodiment, the multiple pill dispensers 300 may be joined together to create a family of dispensers. In this embodiment, the pill dispenser 300 also includes magnets 315. The magnets 315 are disposed on opposed side walls 338 of the inner housing 313. It should also be understood that the magnets 315 could also be positioned on the side walls of the outer housing 316 instead; on either the interior or exterior of the outer housing 316. As shown in FIGS. 10 and 25, multiple pill dispensers 300 and bottles 312 can be aligned and magnetically secured together to create a reconfigurable grouping of dispensers.

IV. Twist-to-Operate Dispenser

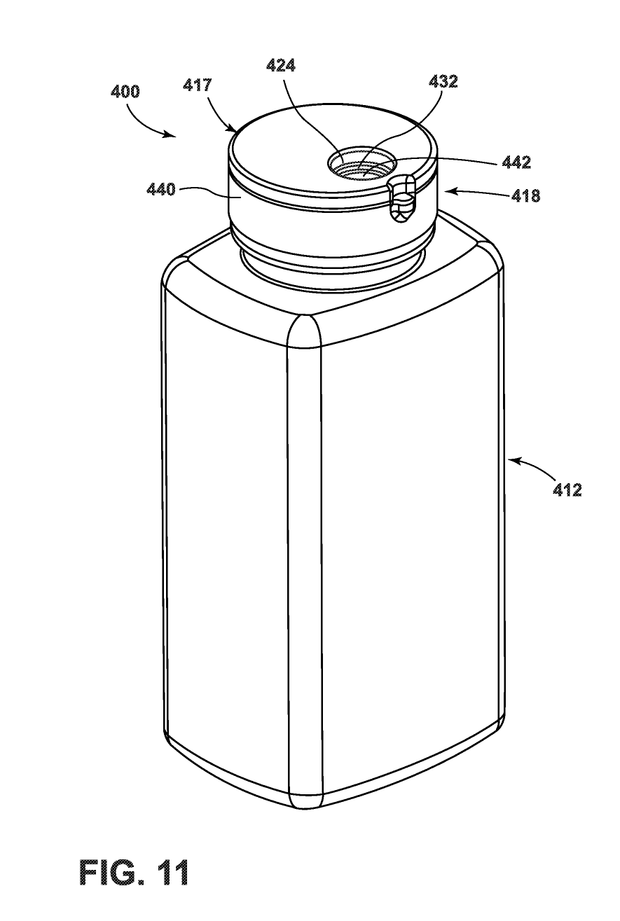

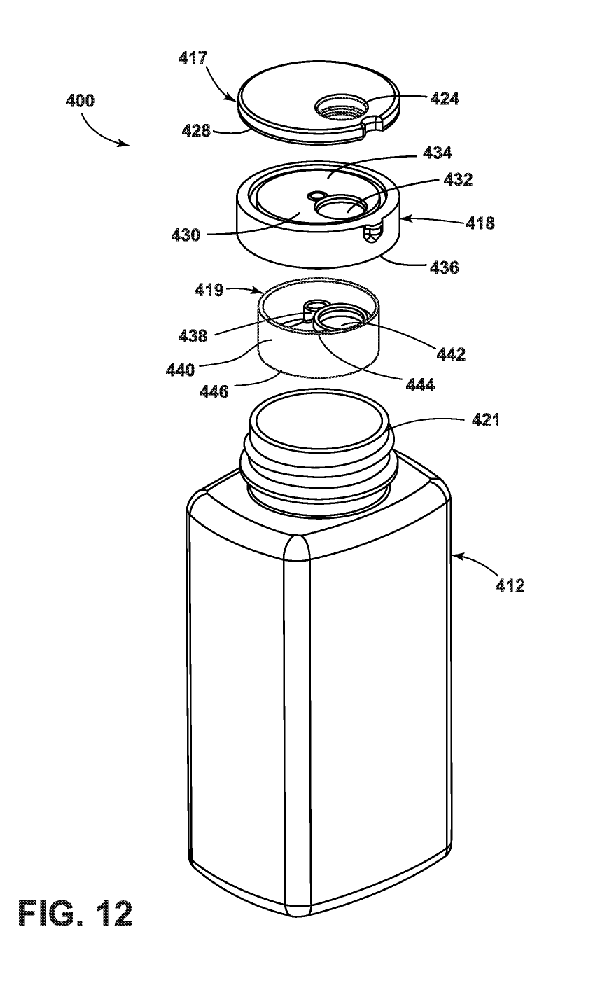

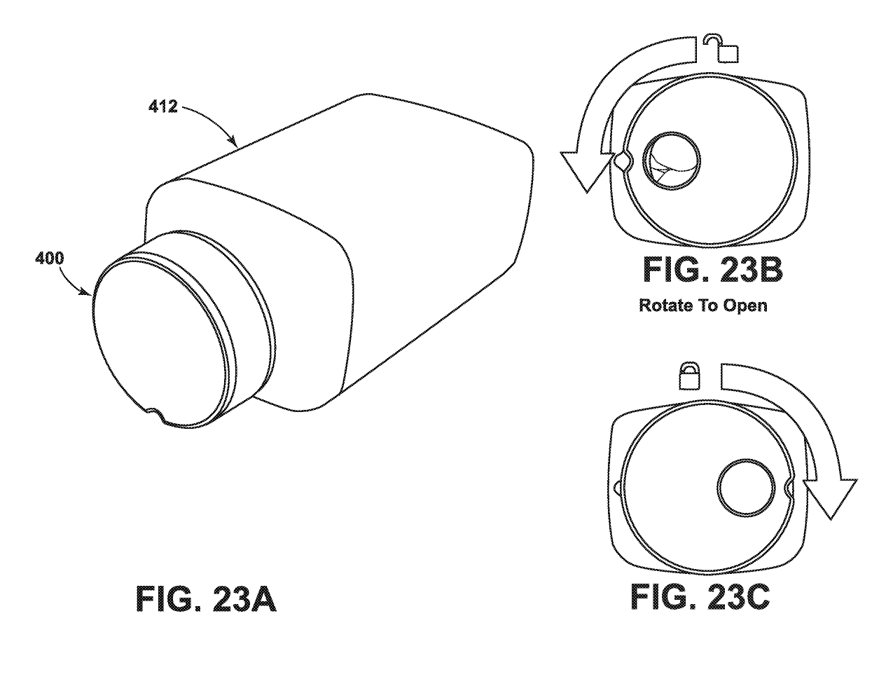

A pill dispenser in accordance with one aspect of the present invention is shown in FIGS. 11, 12, and 23A-C and generally designated 400. The pill dispenser 400 is for use with a conventional pill bottle 412 and, generally speaking, is a twist-to-operate type pill dispenser. The pill dispenser 400 is configured to dispense one pill at a time.

The pill dispenser 400 generally includes a rotating cap 417, a threaded collar 418, and a rotating funnel 419. The rotating cap 417 is a substantially disc-shaped member that includes a dispensing window 424 opening therethrough. A lower surface 428 of the rotating cap 417 includes a downwardly extending post (not shown), the purpose of which will be described hereinafter.

The threaded collar 418 includes an upper surface 430 with an intermediate window 432 and a center hole 434 therethrough. The threaded collar 418 also includes a flange or collar 436 that depends down from the perimeter of the upper surface 430; the collar 436 is internally threaded and may be releasably screwed onto the externally threaded, standard-sized mouth 421 of the pill bottle 412.

The rotating funnel 419 includes a center boss 438, an outer flange 440, and an interior window 442. The rotating funnel 419 also includes a funnel 444 that transitions from a lower surface 446 of the outer flange 440 to the interior window 442.

When the components of the pill dispenser 400 are assembled, the threaded collar 418 is disposed between the rotating cap 417 and rotating funnel 419. The post (not shown) of the rotating cap 417 passes through the center hole 434 of the threaded collar 418 and is received in the center boss 438 of the rotating funnel 419. The post and center boss 438 may include an alignment feature to ensure that when the components are assembled the dispensing window 424 and interior window 442 are aligned.

In use, the pill dispenser 400 is screwed onto the mouth 421 of the pill bottle 412. The user may turn the rotating cap 417, which also turns the rotating funnel 419, because the two components are connected by their respective post and center boss 438. The rotating cap 417 is selectively turned until all three windows—the dispensing window 424, the intermediate window 432, and the interior window 442—are aligned, defining an open position in which the pills therein may be dispensed. The pill bottle 412 may be turned upside-down or angled down, and the pills drop into the funnel 444 and are directed toward the aligned windows 421, 432, and 424. The windows 421, 432, and 424 are sized such that a single pill will be dispensed at a time. If the pills are temporarily stuck, the pill bottle 412 can be shook, to dislodge any stuck pills. Once the proper number of pills has been dispensed, the rotating cap and funnel 417 and 419 can be turned, such that the windows 421, 432, and 424 are not aligned, thereby preventing additional pills from being dispensed.

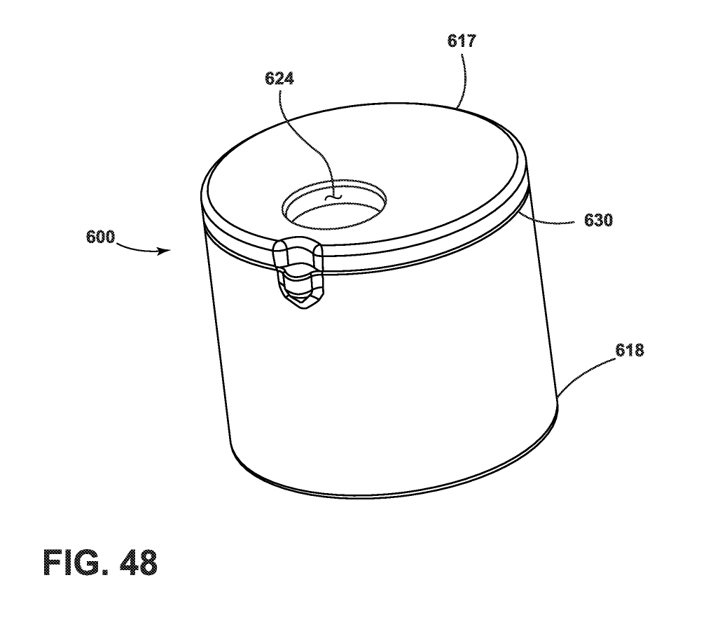

A pill dispenser in accordance with another aspect of the present invention is shown in FIGS. 48-50 and generally designated 600. The pill dispenser 600 is for use with a conventional pill bottle (not shown) and, generally speaking, is a twist-to-operate type pill dispenser. The pill dispenser 600 is configured to dispense one pill at a time.

The pill dispenser 600 generally includes a rotating cap 617 and a housing 618. The rotating cap 617 is a substantially disc-shaped member that includes a dispensing window 624 opening therethrough. A lower surface 628 of the rotating cap 617 includes a downwardly extending post (not shown), the purpose of which will be described hereinafter.

The housing 618 includes a threaded collar 636 that depends down from the perimeter of the housing 618; the collar 636 is internally threaded and may be releasably screwed onto the externally threaded, standard-sized mouth of a pill bottle (not shown). An upper surface 630 of the housing 618 includes two or more openings 632 and a center boss (not shown) therethrough. The housing 618 also includes two or more funnels 619 that transition from a lower surface 646 of the housing 618 to the openings 632 through the upper surface 630 of the housing 618. In the illustrated example, the funnels 619 are shown as being arranged side-by-side across the diameter of the housing 618; however, other configurations are also contemplated here. For example, the two funnels 619 may be tangent or radially spaced. Further, more or fewer funnels are also contemplated.

When the components of the pill dispenser 600 are assembled, the post (not shown) of the rotating cap 617 is received in the center boss of the housing 618. The post and center boss may include a retention feature to ensure that the components remain assembled.

In use, the pill dispenser 600 is screwed onto the mouth of a pill bottle. The user may turn the rotating cap 617 to align the dispensing window 624 with one of the openings 632, defining an open position in which the pills therein may be dispensed. The pill bottle can be turned upside-down or angled down, and pills will drop into the funnels 619 and be directed toward the openings 632. The pill that falls into the funnel 619 that is aligned with the dispensing window 624 will be dispensed, the other pill that falls into the second funnel 619 is “loaded”. With the pill bottle still inverted, or at least angled down, the user may again turn the rotating cap 617 until the dispensing window 624 is aligned with the second funnel 619, to dispense a second pill. The funnels 619 are sized such that a single pill will be dispensed by each. If the pills are temporarily stuck, the pill bottle can be shook to dislodge any stuck pills. Once the proper number of pills has been dispensed, the rotating cap 617 can be turned, such that the dispensing window 624 is no longer aligned with either of the openings 632, thereby preventing additional pills from being dispensed.

V. Flip-to-Operate Dispenser

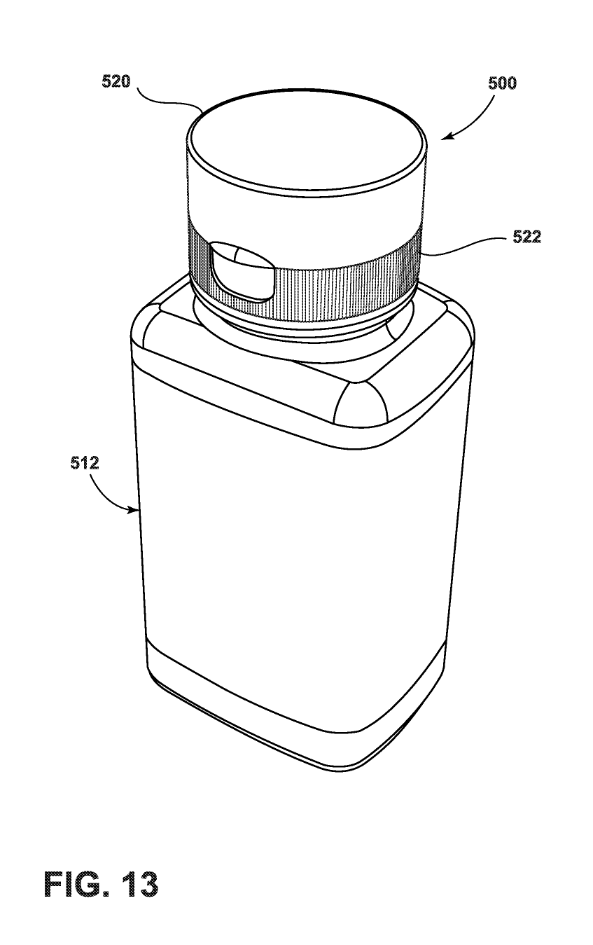

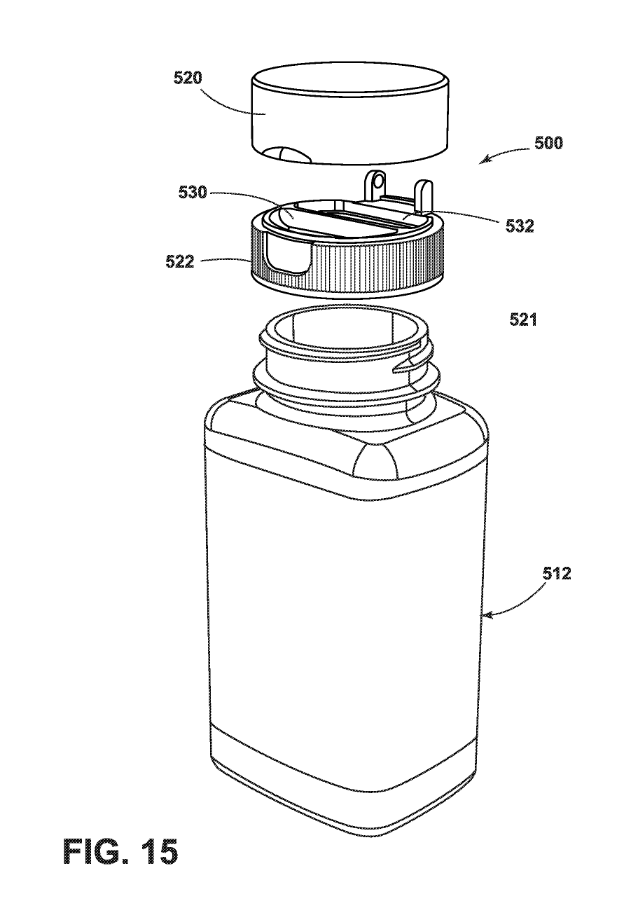

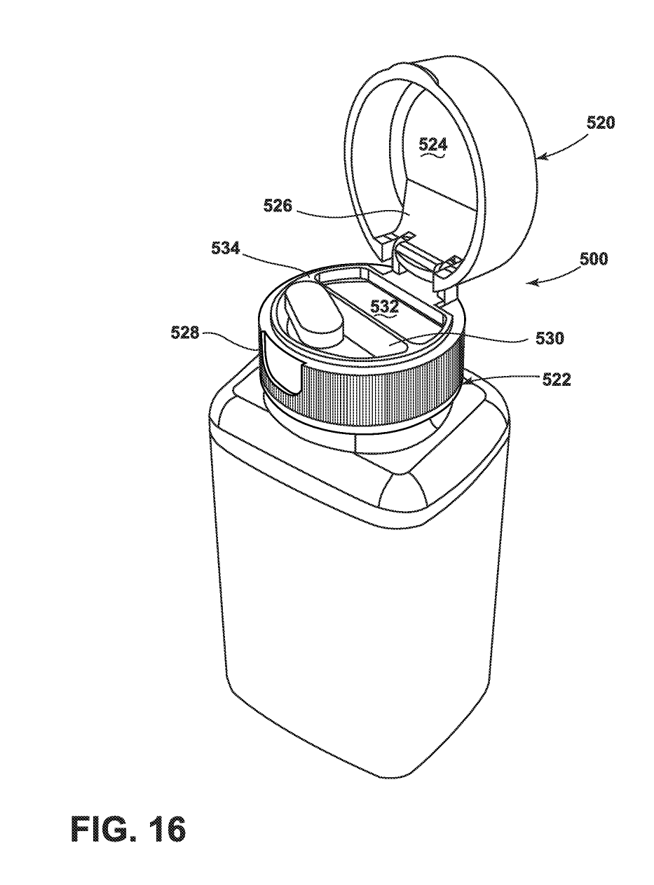

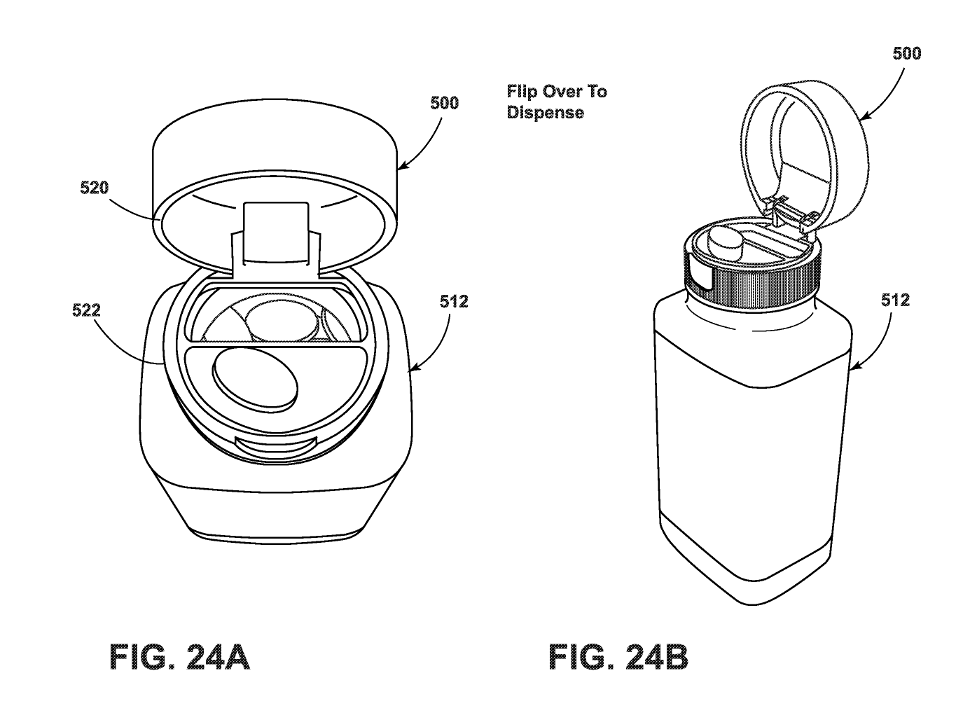

A pill dispenser in accordance with one aspect of the present invention is shown in FIGS. 13-16 and 24A-B and generally designated 500. The pill dispenser 500 is for use with a conventional pill bottle 512 and, generally speaking, is a flip-to-operate type pill dispenser. The pill dispenser 500 is configured to dispense one pill at a time.

The pill dispenser 500 generally includes a cap 520 and a housing 522. The cap 520 is a generally (inverted) cup-shaped member and includes an interior space or chamber 524 and a ramped surface, referred to herein as ramp 526, disposed on an interior surface of the cap 520. The cap 520 is hingedly mounted to the housing 522. It is contemplated that the cap 520 includes a feature to keep the cap 520 closed when not in use, and even when inverted. Such features may include a detent nub, a latch, or other suitable means for selectively retaining the cap 520 in the closed position.

The housing 522 includes a flange or collar 528, and a tray 530 and opening 532 disposed on an upper surface 534 of the housing 522. The collar 528 is internally threaded and may be releasably screwed onto the externally threaded, standard-sized mouth 521 of the pill bottle 512. In the illustrated example, the tray 530 and opening 532 substantially split or evenly divide the upper surface 534. Further, in the illustrated example, the tray 530 and opening 532 are arranged side-by-side in a fore-aft relationship with respect to the hinge that mounts the cap 520. Of course, other side-by-side arrangements are also contemplated herein. Further, although not shown in the drawings, the underside of the housing 522 includes a sloped surface or funnel. The funnel is disposed under the tray 530 and is sloped toward the opening 532 to assist in funneling pills in the bottle toward the opening 532.

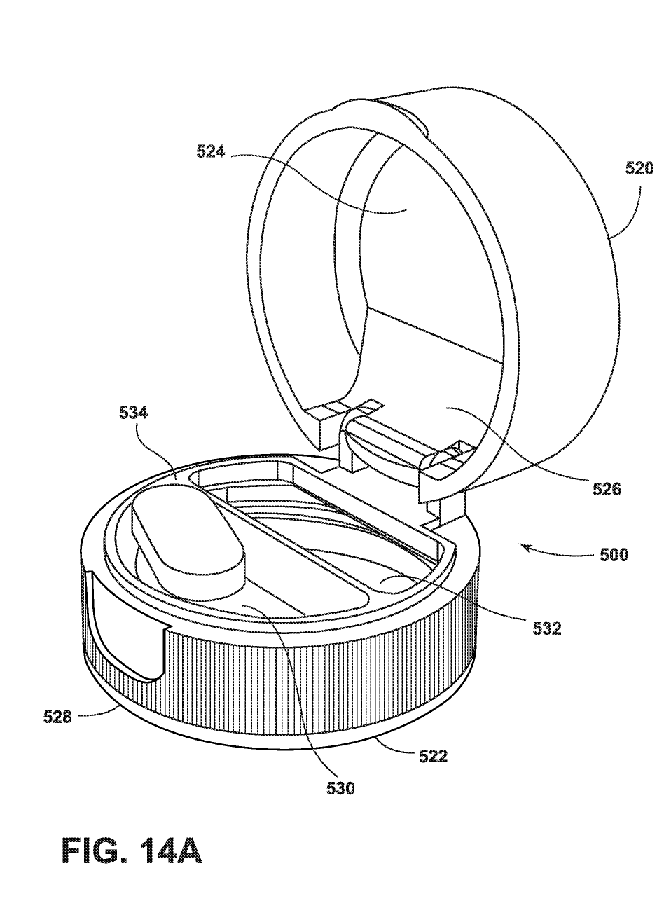

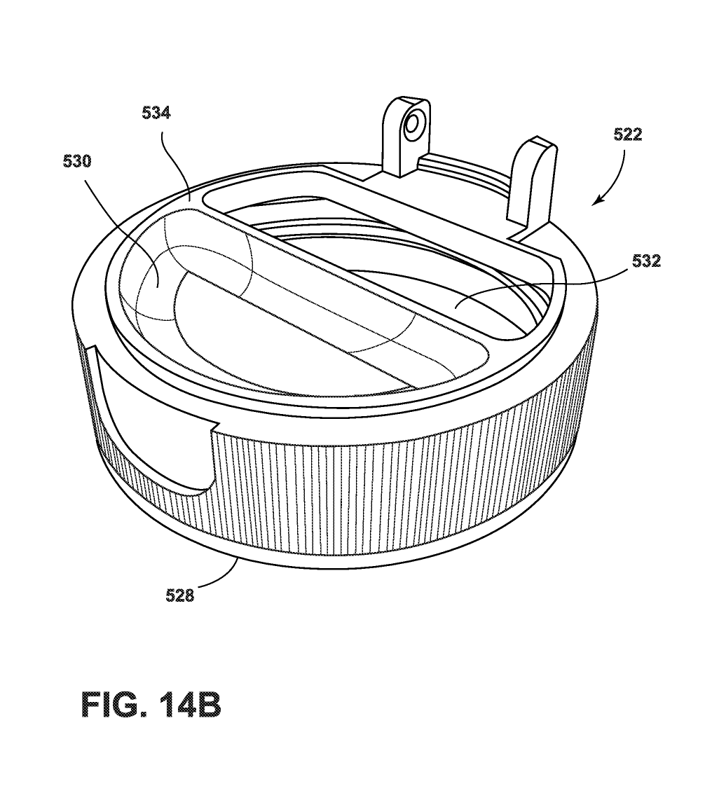

Referring now to FIG. 14B, Applicants have discovered an effective relationship between the size of the tray 530 and opening 532 relative to the size of the intended-use pill. For example, the opening 532 may be sized to be in the range of 125-150% wider and 125-150% longer than the pill for which the pill dispenser 500 is designed for use with. More particularly, the opening 532 may be sized approximately 125% of the width and 125% of the length of the intended pill. Similarly, the tray 530 may be sized to be in the range of 125-150% wider and 125-150% longer than the pill for which the pill dispenser 500 is designed for use with. More particularly, the tray 530 may be sized approximately 125% of the width and 125% of the length of the intended pill. In another embodiment, it is contemplated that the tray 530 could be larger, to capture more than one pill. In this embodiment, to capture two pills on the tray 530, the tray 530 could be sized approximately 225% of the width and 125% of the length of a single pill. Alternatively, the tray 530 could be sized approximately 125% of the width and 225% of the length of a single pill.

Further, Applicants have discovered an effective relationship between the height of the chamber 524 relative to the size of the intended-use pill. For example, the chamber 524 height may be sized to be in the range of 125-150% of the width of the pill for which the pill dispenser 500 is designed for use with. More particularly, the chamber 524 height may be sized to be approximately 132% of the width of the intended pill.

In use, the pill dispenser 500 is screwed onto the mouth 521 of the pill bottle 512. The pill bottle 512 may be flipped upside-down by the user, and then back upright. Inverting the bottle will cause a pill to fall through the opening 532 and onto the tray 530. The pill will be trapped on the tray 530 for dispensing to a user when the bottle 512 is returned upright. As described above, a detent feature in the cap 520 will prevent the cap 520 from opening until selectively opened by the user. The features of the cap 520 and housing 522 are cooperatively arranged to encourage a pill fall through the opening 532 and land on the tray 530. For example, the ramp 526 in the cap 520 is disposed above the opening 532 in the housing 522 such that, when the pill dispenser 500 and bottle 512 are inverted, a pill will fall through the opening 532 and be directed by the ramp 526 toward the tray 530. Also, as described above, the funnel on the underside of the tray 530 is sloped toward the opening 532 to assist in guiding or funneling a pill toward the opening 532. The pill bottle 512 can be shook, to encourage a pill to fall through the opening 532 if needed.

VI. Push-to-Operate Dispenser II

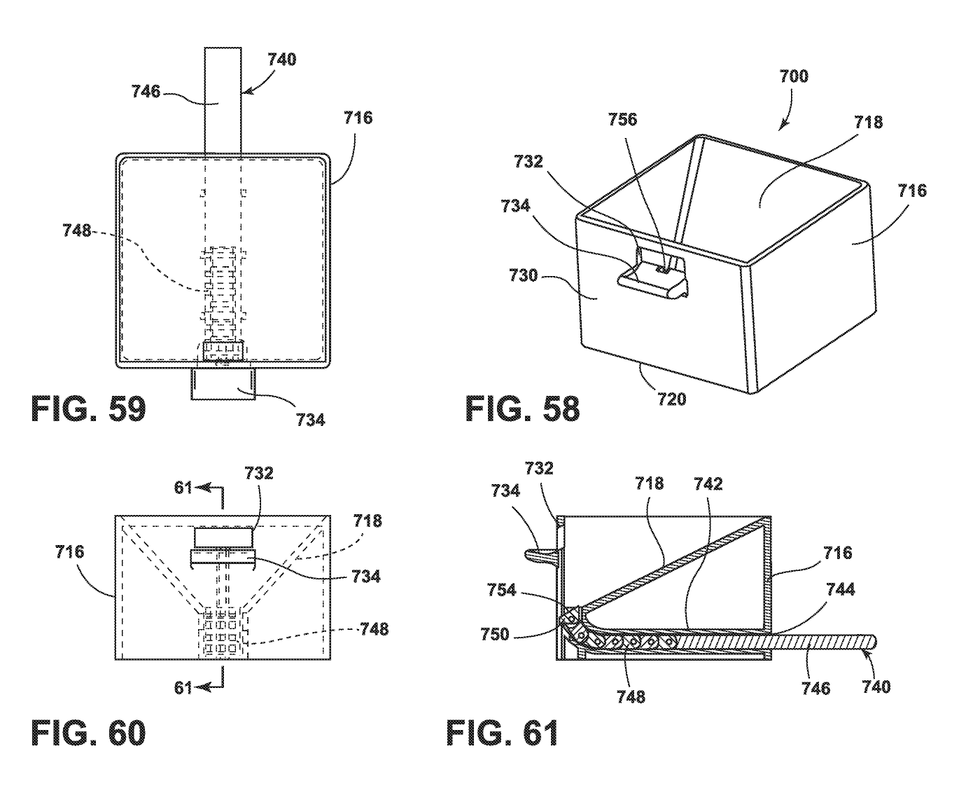

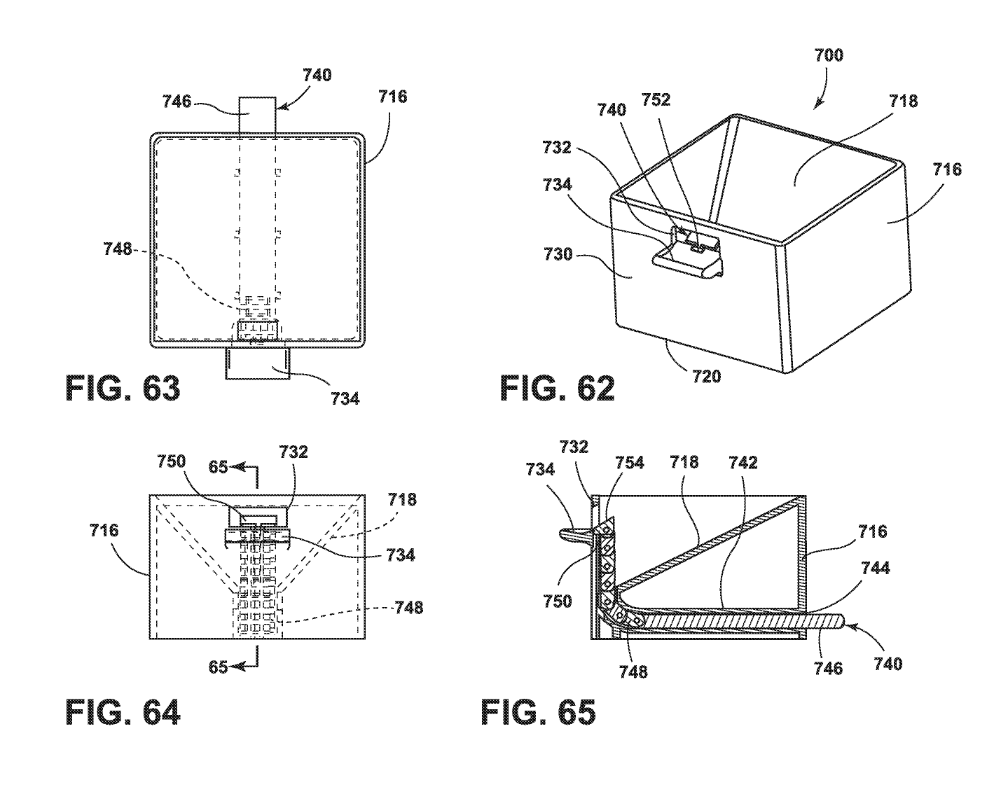

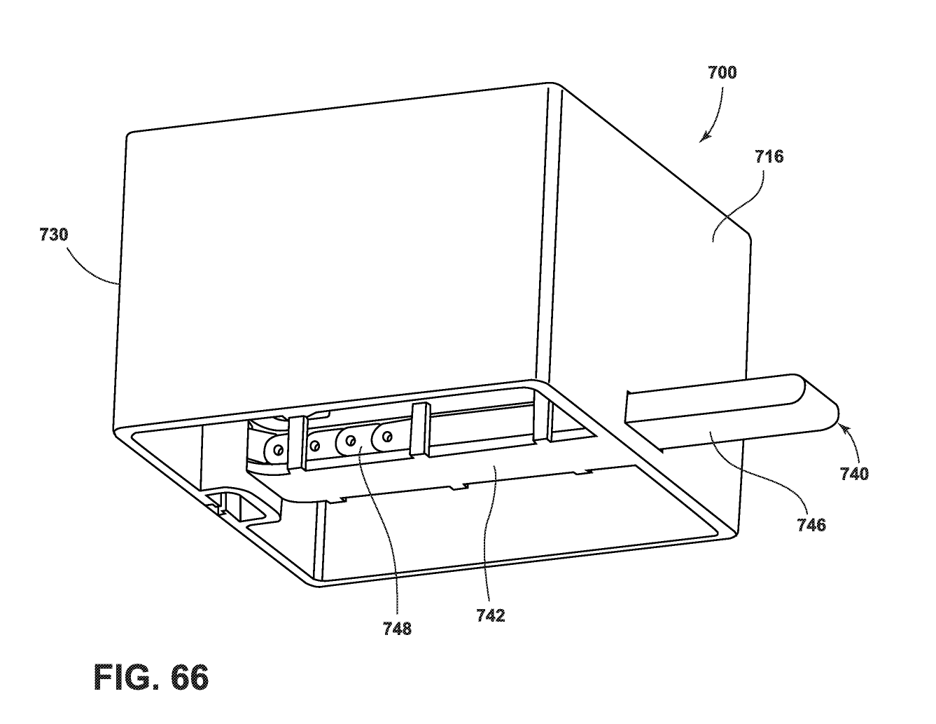

A pill dispenser in accordance with one aspect of the present invention is shown in FIGS. 58-66 and generally designated 700. The pill dispenser 700 may be used with a conventional pill bottle and inner housing, similar to the embodiment illustrated in FIG. 9. Generally speaking, the pill dispenser 700 is a push-to-operate type pill dispenser.

The pill dispenser 700 generally includes a housing 716 that is a substantially box-shaped member. A front wall 730 of the housing 716 includes a dispenser window 732 and a presentation ledge 734 positioned just below the dispenser window 732. The interior of the housing 716 includes a substantially funnel-shaped interior chamber 718 that tapers toward the front wall 730 and a base 720 of the housing 716.

The pill dispenser 700 includes a push bar 740 disposed on the interior of the housing 716, below the chamber 718 and adjacent the base 720. A channel 742 is arranged in the housing 716 near the base 720 and extends from a rear to the front wall 730 of the housing 716. The push bar 740 is slidably disposed within the channel 742. Further, the push bar 740 protrudes out an aperture 744 located in a rear wall of the housing 716.

The push bar 740 includes a substantially rigid portion 746 and a flexible portion 748. In the illustrated example, the flexible portion 748 is formed of chain linked links. An uppermost link 750 includes a T-bar 752 and an angled pill scoop 754. The T-bar 752 is received in a coordinating slot 756 disposed in an interior surface of the front wall 730 of the housing 716.

In use, pills may be placed into the funnel-shaped interior chamber 718 of the pill dispenser 700. The pills fall toward the bottom of the chamber 718 and atop the pill scoop 754. To dispense a pill, a user 7 may push in the rigid portion 746 of the push bar 740, which in turn pushes the flexible portion 748 up. The pill scoop 754 is sized such that a single pill will be lifted as the flexible portion 748 and uppermost link 750 rise. When the uppermost link 750 reaches its highest point, illustrated in FIG. 65, the pill scoop 754 and dispenser window 732 are aligned such that a pill can fall through the window 732 and onto the ledge 734. The angled surface of the pill scoop 754 encourages pills to fall into and through the dispenser window 732. Further, the funnel-shaped interior chamber 718 of the housing 716 and the angled surface of the uppermost link 750 both work to guide t46he pills through the dispenser window 732. Once the pill has been dispensed, the user can pull the push bar 740 back out to the original position.

Though the pill dispenser 700 is shown as having a rectangular geometric shape, other suitable shapes, such as circular, are also contemplated. The sizing of the window 732 may help with proper dispensing of the pills. For example, the window 732 may be sized to be substantially 110% to 150% of the size of the intended pill. Accordingly, it is contemplated that the overall size of the pill dispenser 700 and the dimensions of the features thereof can be scaled up or down, relative to the size of the particular pill, tablet, capsule, etc. intended to be used with the pill dispenser 700.

VII. Control System

The various aspects of the invention may include a control system. For example, the various embodiments of the screw conveyor dispenser, tumbler dispenser, and pill cap dispensers may include a control system. The control system can perform a variety of different functions and can include a variety of different components depending on the application. For example, the control system may include a sensor system for sensing information such as when a pill has been dispensed or when a pill cap has been opened or closed. The control system may include a motor that when driven can automatically or semi-automatically dispense a pill. The control system may include a communication system for communicating with another dispenser, a master unit, or with another device such as a user's phone, laptop, tablet, or other personal device. The control system can include an input such as a button or touch screen for dispensing a pill. The control system can include an output such as a light or speaker. The control system can also include a power source or power connector for transferring or receiving power.

One embodiment of a control system 1000 for a dispenser is illustrated in FIG. 46. The FIG. 46 embodiment includes a controller 1002, a sensor system 1004, a motor 1014, a communication system 1006, an output 1008, an input 1010, and power 1012. Another embodiment of a control system 1000 for a dispenser is illustrated in FIG. 47. In the FIG. 47 embodiment, the control system does not include a motor. Further, FIG. 47 illustrates a device having its own control system 1020 that includes a sensor system 1024, a communication system 1022, and a power source 1032. The device can be a smart phone, laptop, tablet, other personal device, or another dispenser. The two depicted embodiments illustrating control systems are illustrative and are not meant to be exhaustive. Different control systems may include additional, fewer, or different components than the depicted control systems. A number of different optional features are described below that can be implemented with at least one of the depicted control systems or another alternative embodiment of a control system.

A. Communication

A dispenser can optionally include circuitry for dispensing based on communication between a device and the dispenser. A device or device profile may be associated with a user such that the device can communicate with a dispenser and dispense based on the communication. For example, a regimen can be communicated from the device to the dispenser. Alternatively, the dispenser may be programmed and dispense in response to identifying the user is in proximity to the dispenser.

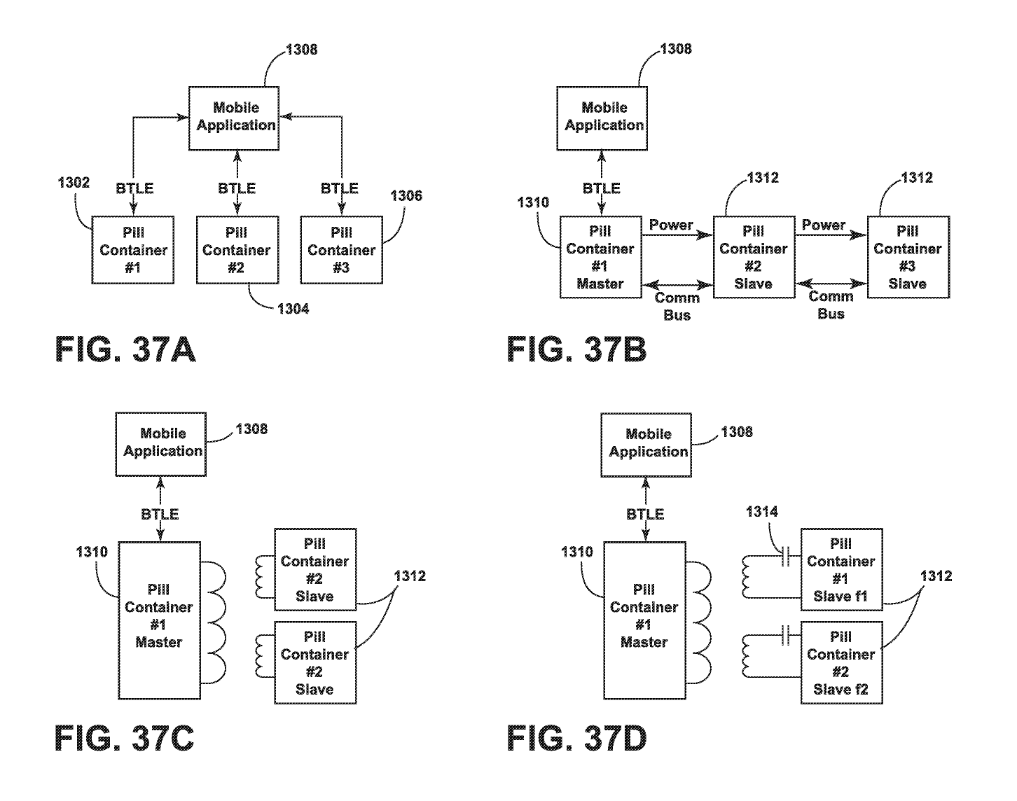

FIGS. 37A-D illustrate four communication scenarios that can be implemented in the various aspects of the invention. FIG. 37A illustrates a scenario where three pill dispenser modules 1302, 1304, 1306 and a mobile device 1308 each contain a communication system capable of Blue Tooth Low Energy (BTLE) communication. Command and control may reside in the mobile application on the smart phone 1308 that is in communication with each of the pill dispensers 1306. Each pill dispenser can be powered by a separate battery or power can be routed to each container from a central power source. FIG. 37B illustrates a scenario where a master pill dispenser 1310 communicates through BTLE to a mobile device 1308. The master pill dispenser 1310 can communicate to one or more slave pill dispensers 1312 containers. For example, the mobile device 1308 can communicate instructions to dispense, which can be relayed to the appropriate slave pill dispenser 1310. The communication between the master pill dispenser 1310 and the slave pill dispensers can occur on essentially any communication protocol, such as One-Wire, I2C, or SPI. Power may be passed along side communication via a bus (or in the case of One-Wire, as part of the bus). FIG. 37C illustrates another scenario where a master pill container 1310 communicates through BTLE to a mobile device 1308. Just as in the previous scenario, the master pill dispenser can communicate to slave pill dispensers 1312, telling them when a command has been received to dispense. However, in this embodiment, power and communication can be wirelessly transmitted from the master pill dispenser 1310. Commands can be sent via in-band communication scheme to each dispenser. FIG. 37D illustrates another scenario where a master pill dispenser can communicate via BLTE to a mobile device 1308. In this embodiment, the master pill dispenser 1310 can selectively turn on slave pill dispensers 1312 by resonating a magnetic field at a matched resonant frequency of the target slave pill dispenser. This resonant element 1314 in the slave pill dispenser 1312 can be series or parallel and the value of the resonant element for each slave pill dispenser 1312 can be different. This way, multiple slave pill dispensers 1312 can be in the field and selectively chosen without logic in the slave pill dispensers 1312. If the slave and master share a common dispense tube, then the master can use an optical and/or proximity sensor (such as infrared) to sense when a pill has been dispensed and turn off the field after the pill has been dispensed. In the current embodiment, the slave dispensers can be made less expensive because the only electrical components included may be a coil, rectifier, and motor.

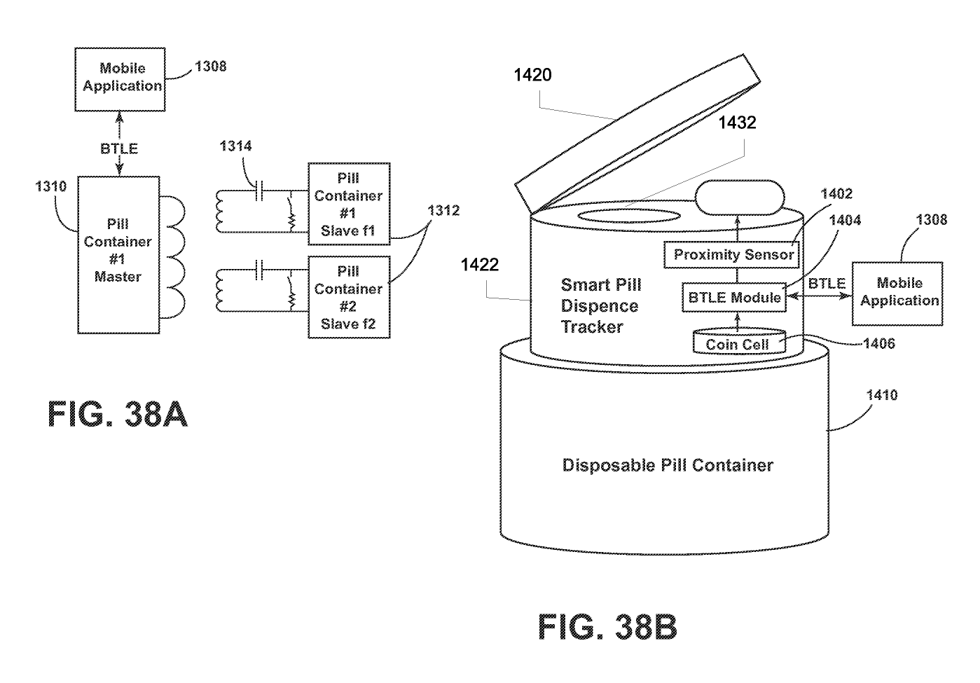

FIG. 38A illustrates another communication scenario where master pill dispensers 1310 can communicate to a mobile device 1308 with BTLE. The master 1310 can selectively turn on slave pill dispensers 1312 by resonating a magnetic field at a matched resonant frequency of the target. The resonant element 1314 in the container can be series or parallel. The slave pill dispensers 1312 can monitor when a pill is dispensed and modulate the magnetic field by closing switch 1316 in order to temporarily include impedance element 1318 in the circuit. The master 1310 can monitor the field for a change to the signal caused by the change in impedance, which indicates that a pill has been dispensed and can then disable the field providing power to the slave 1312. In this embodiment, the cost of a slave pill dispenser can be kept low because the amount of electrical components are reduced to essentially a coil/cap, rectifier, motor, switch, impedance element, and an optical or other sensor that drives the impedance when tripped.

FIG. 38B illustrates a smart article dispenser system for use with essentially any of the pill cap dispensers discussed above. In the depicted embodiment, the pill cap dispenses one pill at a time and includes electronic components that can track and communicate when a pill has been dispensed. Specifically, the smart pill dispense tracker components may include a cap 1420, a housing 1422 having an opening 1432, a proximity sensor 1402, a BLTE module 1404, and a battery 1406. The smart pill dispense tracker can be implemented in a variety of different pill cap dispensers that are adapted to attach to a disposable pill container 1410. The replacement lid or pill cap dispenser can be replaceable among different pill types. The BTLE module 1406 allows the user to track how many pills have been dispensed, how many are left, and usage patterns among other things. The proximity sensor 1402 may be an accelerometer, infrared detector, push button, or capacitive sensor that can detect either when a pill has been dispensed or when there has been movement associated with the smart pill dispense tracker.

B. Pill Identification

The various aspects of the invention can dispense pills of various shapes, sizes, and types. A pill dispenser control system can dispense pills based on a variety of factors. For example, a pill dispenser control system can dispense pills from multiple pill dispensers tailored for a specific user. In one embodiment, the pill dispenser control system can identify or is programmed with the identify of a plurality of different types of pills and their location in a specific pill dispenser.

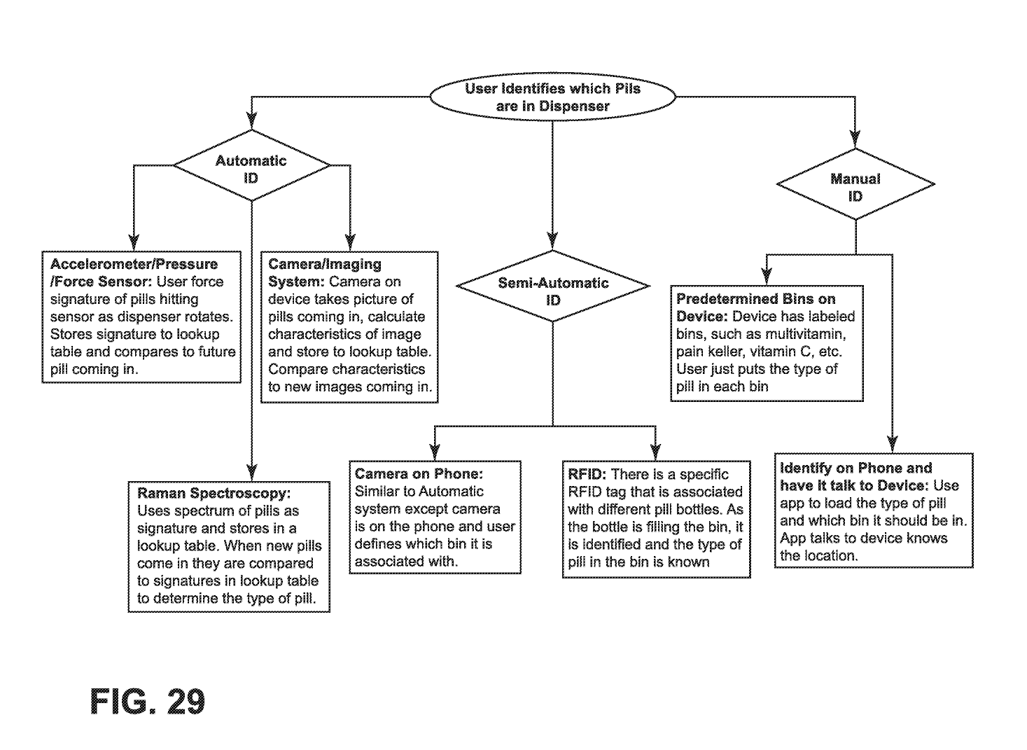

Referring to FIG. 29, the identification can be automatic, semi-automatic, or manual. FIG. 29 illustrates several processes of identifying which pills are in the different containers of the pill dispenser. The manual identification processes refer to a user inputting information for each pill type and which pill dispenser the pill is located in. Semi-automatic identification refers to a process where some information is provided, but the control system provides assistance in the identification. The automatic identification process may be implemented without input from the user at all, or with input from the user the first time a pill is initiated in the system. Using an automatic identification process, a user can pour pills into a pill dispenser or install a pill container into a pill dispenser and the pill dispenser system automatically identifies the pills.

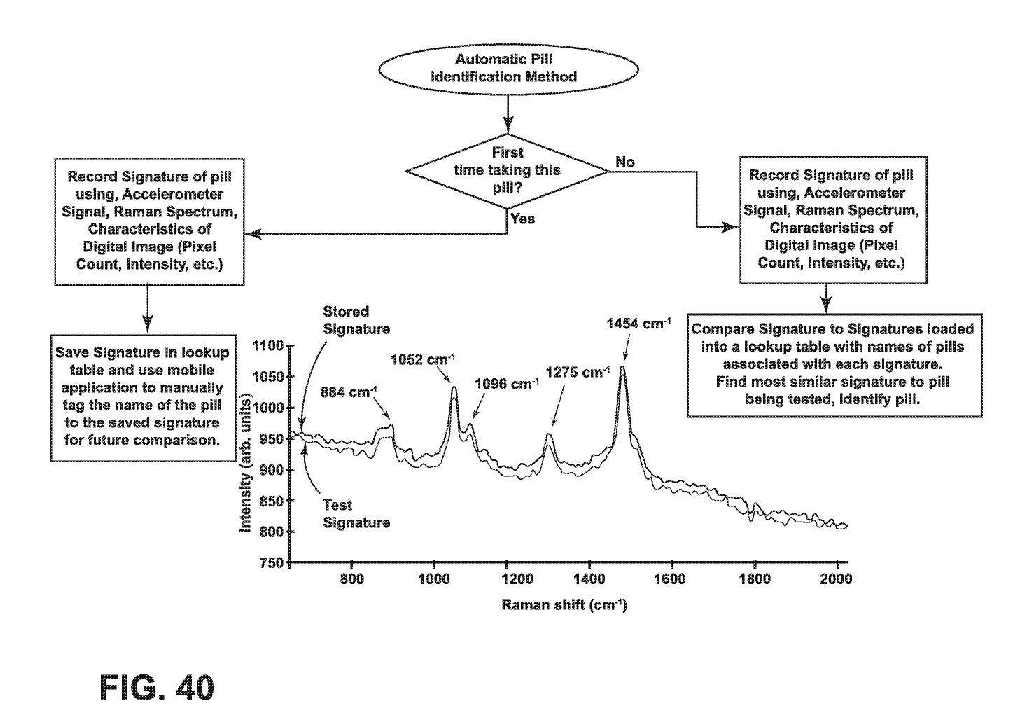

Automatic pill identification can be implemented a number of different ways using a variety of different sensors. In general, a unique signature of a known pill can be obtained and saved in memory for comparison to unknown pills and automatic identification. The unique signatures can be pre-programmed in the pill dispensing system. Alternatively, or in addition, the pill dispensing system may have the capability to create new unique signatures for unrecognized pills, as illustrated in FIG. 40. If it is the pill dispensing system's first time seeing a pill, an initialization process can be implemented to record the signature of the pill using an accelerometer, Raman spectroscopy, characteristics of a digital image (e.g. pixel count, intensity, etc.), or essentially any other signature methodology. The signature can then be saved in a look-up table with the identity of the pill, obtained from the user. In the future, unknown pills can be compared to that signature and matching signatures can be identified as the pill type identified during this initialization process.

FIG. 40 illustrates a stored and test signature obtained using Raman spectroscopy. Raman spectroscopy involves a frequency spectrum of light being recorded. Based on characteristics of the pill certain molecules in the pill are excited by light and emit a response of a certain wavelength. This depends on the makeup of the pill and by identifying peaks in the signature a unique response can be associated with the pill. A small camera in the device could also be used to identify pills. As they travel into the pill container or hopper a picture can be taken. The RGB plans can be broken up and the image intensity can be analyzed providing information about what that pill looks like. This can identify the pill or if it is coupled with another method, may assist in identifying the pill type.

One embodiment of automatic identification makes use of an accelerometer, pressure sensor, or force sensor. For example, in the tumbler pill dispenser or conveyor pill dispenser, a sensor can determine a force signature of pills hitting the sensor as the dispenser rotates. This signature is unique or statistically reliably different among different types of pills such that the force signature of unknown pills can be compared to a stored table of force signatures in order to determine the type of pill. The signatures can be learned by the pill dispenser system through a user assisted process by which the user provides pills unknown by the system, the system collects a force signature and prompts the user to identify the pills. From then on, when the pill dispenser control system detects that force signature, it can identify them correctly as the pills that the user initially identified during initialization. Instead of a force sensor, a camera or imaging system may be used instead. The camera or imaging system can take a picture of pills, calculate characteristics of the image and store that information into a look-up table. Those characteristics can be compared to new images when unknown pills are provided to the system. Matching characteristics can be used to determine the pill type. Yet another embodiment of automatic identification may include use of a Raman spectroscopy. A sensor can conduct a spectrum analysis of pills and generate a Raman spectroscopy signature, which can be stored in a look-up table. A spectrum analysis of unknown pills can be conducted and the resultant signature can be compared to known Raman spectroscopy signatures in order to identify the type of pills.

One embodiment of semi-automatic identification includes a camera phone where a user can take a picture of a pill and define which pill dispenser the pills are located in. For example, the control system prompts the user to select the dispenser where pills are being loaded, take a picture of the pill or pills being loaded, and then from the picture the user's device can identify the type of pill, how often it should be taken, dosage, etc. by looking up the information in a database based on the image of the pill.

In another embodiment of semi-automatic identification, an RFID tag is associated with different pill containers. As the container is filling the pill dispenser, the RFID tag communicates with the pill dispenser control system to identify the type of pill so that the control system can store the contents of that pill dispenser.

One embodiment of a manual identification process includes predefined pill dispensers. The pill dispenser system includes a plurality of pill dispensers, each of which have pre-defined labels, such as multivitamin, pain killer, vitamin C. The user loads different types of pills into the appropriate pre-defined pill dispensers.

Another manual identification process includes identifying the pill type and pill dispenser loading location on a personal device that communicates that information to the pill dispenser control system. For example, an application on a user's smart phone may have a picture of a pill dispenser system setup where the user can select a pill dispenser and select the pill type from a drop down box, which is then communicated to the pill dispenser system so that it knows the location of those pills in the system.

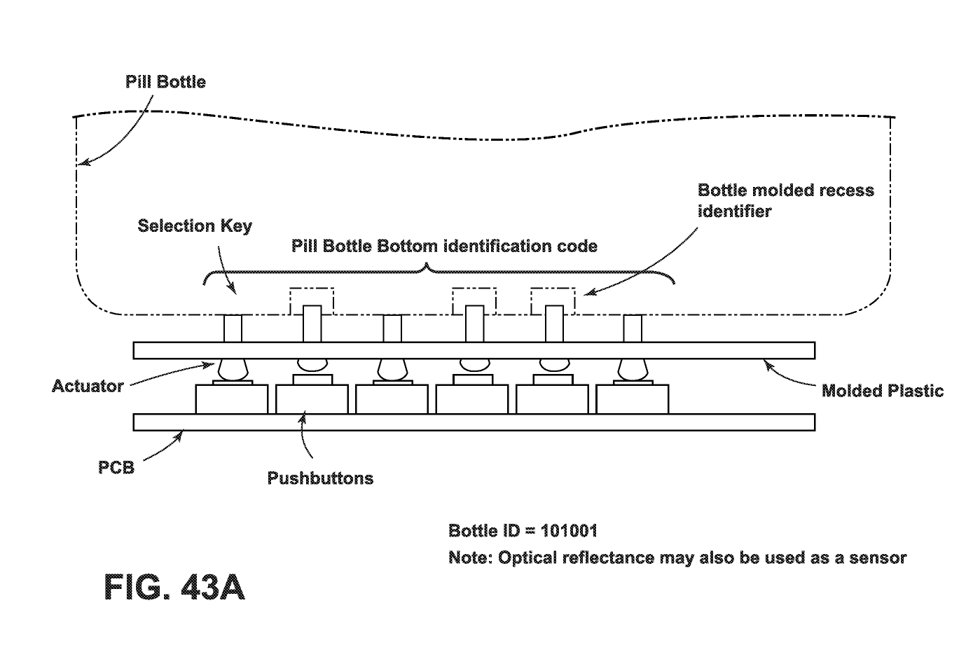

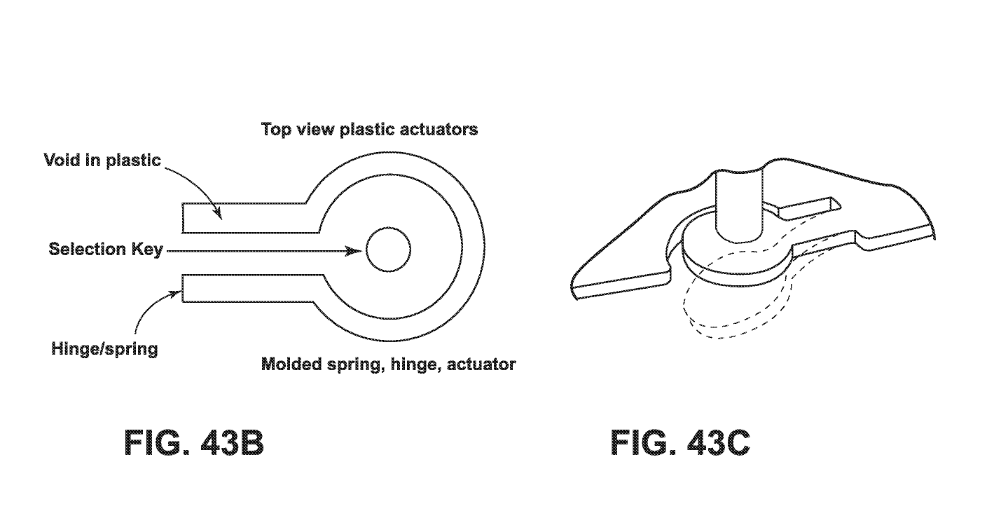

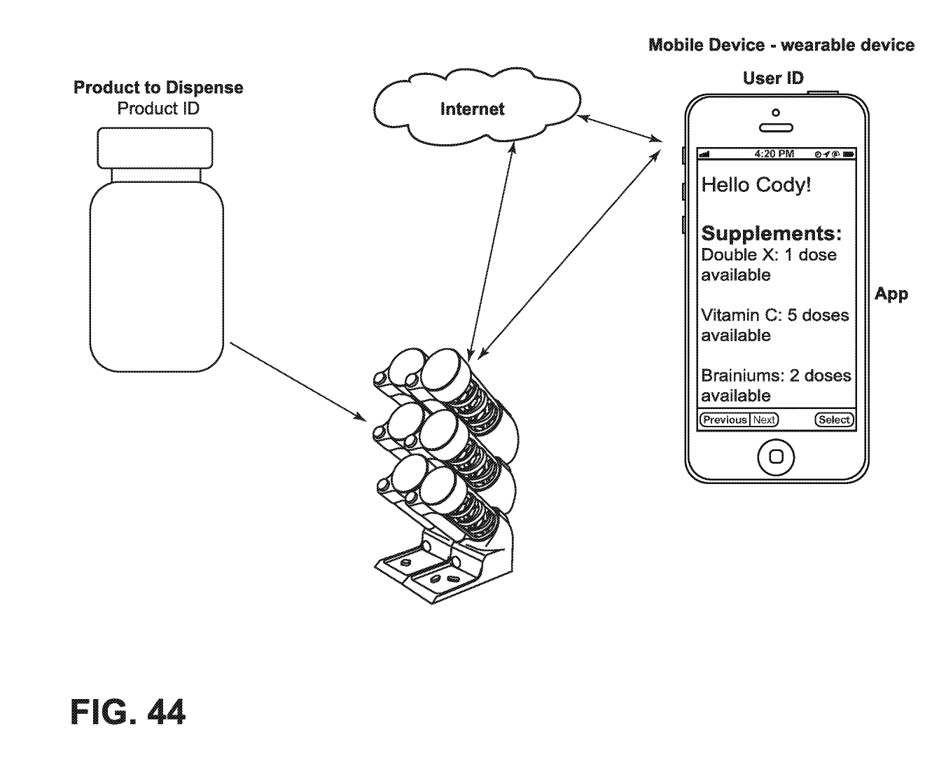

Pill identification can be conducted based on identification of the pill container instead of the pills themselves. For example, a pill container may include an RFID tag, bar code, physical selection key, or another identifier. FIG. 43A illustrates one embodiment a pill bottle bottom identification code interfacing with a pill dispenser system. The pill bottle bottom is molded with a physical pattern or selection key such that when installed in a pill dispenser, a set of actuators are actuated and push buttons are activated according to the selection key pattern. FIG. 43C illustrates a perspective view of a hinge/spring or living spring actuator that can flex to activate one of the push buttons. FIG. 43B illustrates a top view of the living hinge actuator. In the depicted embodiment, there are six actuators that can be activated. Three of the actuators are activated because the bottom of the pill bottle interfaces with the actuator in order. Three of the actuators are not activated because the bottom of the pill bottle includes a molded recess to accommodate those actuators. The result is that three of the pushbuttons are pressed and a bottle ID of 101001 is provided to the pill dispenser control system. The pill dispenser control system may include a look-up table where the identity of the pills in that bottle ID can be looked up. If that bottle ID is unknown, the system may prompt the user to provide information about the pills in that bottle so that it can be added to the look-up table.

In one embodiment, once a pill bottle is identified, information can be retrieved from an application, look-up table, or from the Internet based on the identification. For example, using a product ID, product count, product type, package size, use limits and recommendations, used with and not used with information, and life information can be obtained and used to intelligently dispense pills. For example, if two pills should not be taken together the pill dispensing system can coordinate their dispensing so that they are both not dispensed during a disallowed time period. The dispenser may have a dispenser ID that is associated with a usage schedule, inventory on hand, reorder triggers, user records and usage, dispenser serial number, products being used, and diagnostic information. The user device may have a user ID that includes user identification settings, access and security settings, inventory control, reordering, scheduling, recommendations, product and usage promotions, health feedback and suggestions, software upgrades for the application and the dispenser software or firmware, notifications, diagnostics, warranty and service information, and product and training information.

In one embodiment, additional resolution for identification can be obtained by combining multiple identification methods. Accelerometers and pressure sensors might not be able to identify a pill precisely, but as the device rotates and the pills fall, they can fall on an accelerometer. The recorded peaks will vary with the size and shape of the pill. This can provide a first level of identification for pills by sorting them into certain categories such as large or small, round or rectangle and then a camera or spectroscopy methods could be used to identify the pill exactly. Alternatively, the user may be provided with a list of possible pill types and they could complete the identification.

C. Scheduling

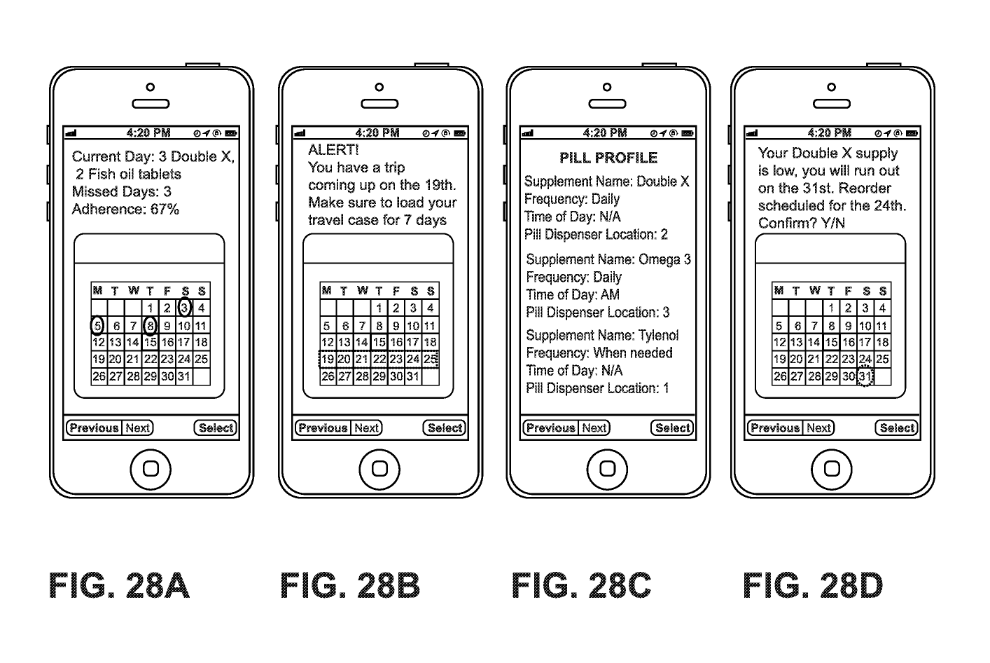

The pill dispenser control system can interact with a user's personal device in order to facilitate various scheduling functionality. For example, FIGS. 28A-D illustrates several screenshots from a smart phone application that can communicate with a pill dispensing control system. FIG. 28A illustrates an application interfacing with a user's calendar that can mark days the user missed their pills. The application can track and provide the user an adherence percentage showing how often they take their pills. In the current embodiment a general adherence value is provided for all pill adherence, but the adherence value could be provided for individual or groups of pills. FIG. 28B illustrates the application notifying the user of an upcoming trip based on their calendar and reminds them to plan ahead by filling up their travel pill case. FIG. 28C illustrates the application pill profile for a user. This shows the pills this user is taking, how often and when they should take them, and where the pill is located in the dispenser. In this way, the smart phone can communicate intelligently with the pill dispensing system to control dispensing. FIG. 28D illustrates reordering capability of an application. The personal device can track pill levels and automatically reorder pills when the amount of pills falls past a threshold.

D. User Identification and Security

In some embodiments, the pill dispenser control system may be programmed to identify a user is in proximity to the pill dispenser system. For example, the pill dispenser control system may include a communication system or proximity detection system that can detect a user's personal device. The dispenser can interface with a user's personal device such as a smart phone or weight management device in order to tailor the user's pill dispenser experience.

The user's device may specifically communicate a user ID to the pill dispenser system. Alternatively, the user's device may communicate identifying information that the pill dispenser system can use to identify the user. For example, a user's weight management device (e.g., such as a wrist band) may communicate various biometrics or other identifying information about an individual. The user's device may store or have access to information about the user such as heart rate, pulse, activity level, location data, prescriptions, or other biometric or personal information. These metrics may allow the pill dispenser system to identify the user. When the person comes into proximity of the pill dispenser, the personal device can communicate with the dispenser system so that they can be identified. Once identified, the pill dispenser system can operate based on a user's pill profile in order to dispense the appropriate pills. This identification can also provide security by locking the pill dispenser and only providing access to the pills associated with an authorized user.

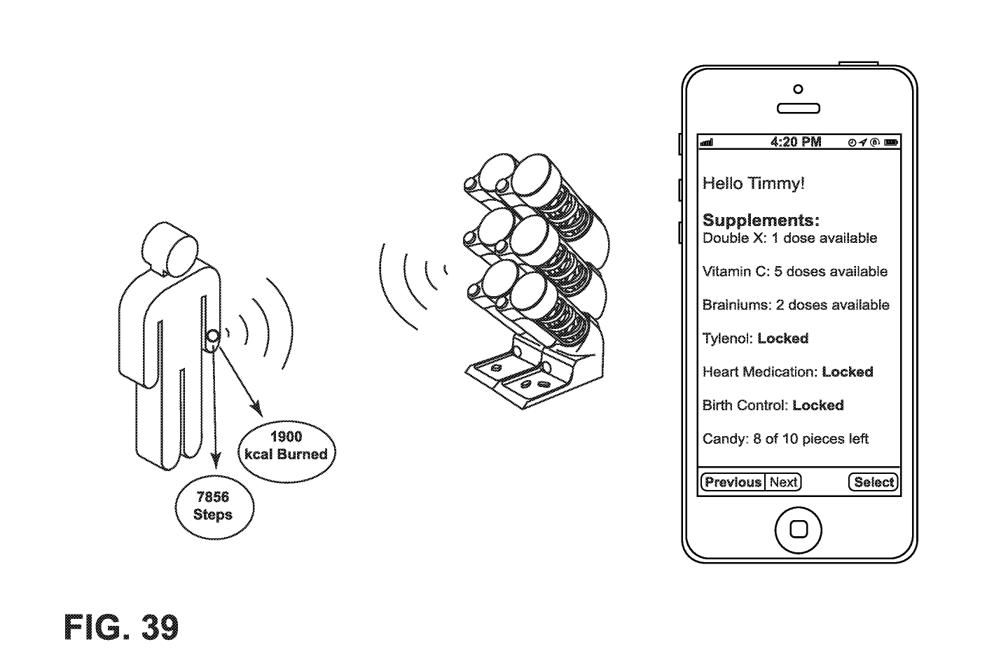

The various aspects of the invention may include a pill dispenser control system that implements security for pill dispensing. For example, FIG. 39 illustrates a locking feature. In general, in his embodiment, when a person comes in proximity of the dispenser, only pills that they are allowed to take can be dispensed and all other pill dispensers are locked. The lock can lock the user out so that the pills cannot be manually accessed and also so that the user cannot remotely instruct a pill dispense from an unauthorized dispenser. The pill dispensing system can return to a locked state unless an authorized user is in proximity interfacing with it.

Although much of the description is written within the context of pills and pill dispensers, items other than pills can be dispensed from the dispensers. For example, in FIG. 39, a child interfaces with a dispensing system that includes a plurality of vitamins and supplements, but also includes a container with candy. Parents have programmed the dispensing system to allow the child to obtain 10 pieces of candy a week so that they learn responsibility and good habits, but they don't have access to the adult medication in the dispenser such as heart medication or birth control. Since the dispenser can handle small pills, it may also be used for candy in order to restrict the amount of candy a child would be allowed throughout a day, week, or other time period. The parents can set the limits and then after it was reached, the child would be locked out. This can teach good habits and how to portion out the candy allotment for the day or week without the parents having to govern it themselves. Not only can parents set their personal parameters from their personal device such as a smart phone, they can also set the parameters for their children and allow more or less candy as an incentive tool, for example. The dispenser can also read other information off of a fitness tracker or other personal device when you come into proximity with it. The dispensing system can be programmed to dispense on other factors as well. It can dispense based on weight, age, activity, other factors, or a combination thereof. For example, overweight people may be restricted from candy until they have recorded more than 5000 steps that day. This can also be used for adults if they want a piece of candy or a treat and they can only get it if they have taken enough steps.

E. Notifications

The pill dispenser control system may include a notification system for notifying a user of various events. For example, the pill dispenser control system may include lighting or speakers that can be activated in order to notify a user that it is time for a pill to be taken. In addition, the pill dispenser control system may determine that a dosage has been missed. For example, if the control system includes a motion, a lack of activity in the sensor for a threshold amount of time can trigger a notification. Similarly, an accelerometer can count how many pills dispensed and notify the user by flashing or turning on an LED that pills should be reordered.

U.S. application Ser. No. 13/455,634 entitled PILL DISPENSER, filed on Apr. 25, 2012 is hereby incorporated by reference in its entirety.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A smart article dispenser system for dispensing consumable articles, the smart article dispenser system comprising:
a smart article dispenser comprising:
a housing adapted to removably mount to an article container, the housing including an opening for dispensing articles contained within the article container;
a cap mounted to the housing for covering the opening in the housing;
an accelerometer for sensing smart article dispenser information including at least one of a) information regarding articles contained within the article container; and b) information regarding movement associated with the smart article dispenser;
a communication system for communicating smart article dispenser information to a remote device; and
a battery for powering the accelerometer and communication system;
a remote device in communication with the smart article dispenser, the remote device comprising:
a device communication system for receiving a first portion of smart article dispenser information from the smart article dispenser;
an identification system that obtains a second portion of smart article dispenser information in the form of at least one of a) a picture of the smart article dispenser; b) a picture of a barcode associated with the smart article dispenser; c) a picture of one or more consumable articles; and d) RFID information from an RFID tag associated with the smart article dispenser;
memory that stores the first portion of the smart article dispenser information received from the smart article dispenser and the second portion of the smart article dispenser information obtained by the identification system; and
a device control system that, based on the smart article dispenser information stored in memory, both a) identifies the articles contained within the article container and b) tracks the dispensing of the identified articles contained within the article container.

2. The smart article dispenser system of claim 1 wherein the accelerometer, communication system, and battery are each disposed within the housing.

3. The smart article dispenser system of claim 1 wherein the housing includes an internally threaded neck for mounting to external threads of the article container.

4. The smart article dispenser system of claim 1 wherein the smart article dispenser information includes at least one of: a quantity of articles dispensed, a quantity of articles contained in the article container, and article usage patterns.

5. The smart article dispenser system of claim 1 wherein the accelerometer senses movement associated with the smart article dispenser and the smart article dispenser information relates to movement associated with the smart article dispenser.

6. The smart article dispenser system of claim 1 wherein the articles include at least one of pills, capsules, tablets, and caplets.

7. The smart article dispenser system of claim 1 wherein the articles include at least one of medication, vitamins, and supplements.

8. A smart dispenser system for an article container, the smart dispenser system comprising:
a smart article dispenser including:
a housing adapted to removably mount to an article container, the housing including an opening for dispensing consumable articles contained within the article container;
a cap for covering the opening in the housing; and
a control system including:
an accelerometer for sensing article information;
a communication system for communicating article information to a remote device; and
a power source for powering the accelerometer and communication system
a remote device in communication with the smart article dispenser, the remote device comprising:
a device communication system for receiving a first portion of article information from the smart article dispenser;
an identification system that obtains a second portion of article information in the form of at least one of a) a picture of the smart article dispenser; b) a picture of a barcode associated with the smart article dispenser; c) a picture of one or more consumable articles; and d) RFID information from an RFID tag associated with the smart article dispenser;
memory that stores the first portion of the article information received from the smart article dispenser and the second portion of the article information from the identification system; and
a device control system that, based on the article information stored in memory, both a) identifies the consumable articles contained within the article container and b) tracks the dispensing of the identified articles contained within the article container.

9. The smart dispenser system of claim 8 wherein the cap is hingedly mounted to the housing.

10. The smart dispenser system of claim 9 wherein the accelerometer, communication system, and power source are each disposed within the housing.

11. The smart dispenser system of claim 8 wherein the article information includes at least one of a quantity of articles dispensed, a quantity of articles contained in the article container, and a usage pattern.

12. The smart dispenser system of claim 8 wherein the remote device is at least one of a smart phone, a laptop, a tablet, and a personal device.

13. The smart dispenser system of claim 8 wherein the accelerometer senses movement associated with the smart article dispenser.

14. The smart dispenser system of claim 8 wherein the cap is rotatably mounted to the housing.

15. The smart dispenser system of claim 8 wherein the articles include at least one of pills, capsules, tablets, and caplets.

16. The smart dispenser system of claim 8 wherein the articles include at least one of medication, vitamins, and supplements.

17. A smart dispenser system for dispensing articles, the smart dispenser system comprising: a smart article dispenser;
a mounting means for removably mounting the smart article dispenser to a disposable article container;
an accelerometer for tracking article information;
a communication system for communicating article information to a remote device;
a battery for powering the accelerometer and communication system; and
a remote device in communication with the smart article dispenser, the remote device comprising:
a device communication system for receiving a first portion of article information from the smart article dispenser;
an identification system that obtains a second portion of article information in the form of at least one of a) a picture of the smart article dispenser; b) a picture of a barcode associated with the smart article dispenser; c) a picture of one or more articles; and d) RFID information from an RFID tag associated with the smart article dispenser;
memory that stores the first portion of the article information received from the smart article dispenser and the second portion of the article information from the identification system; and
a device control system that, based on the article information stored in memory, both a) identifies the articles contained within the article container and b) tracks the dispensing of the identified articles contained within the article container.

18. The smart dispenser system of claim 17, the mounting means including a housing having a threaded neck adapted to mount to a threaded article container and an opening for dispensing articles contained within the article container.

19. The smart dispenser system of claim 18 including a cap mounted to the housing for covering the opening in the housing.

20. The smart dispenser system of claim 17 wherein the article information includes at least one of a quantity of articles dispensed, a quantity of articles contained in the article container, and a usage pattern.

21. The smart dispenser system of claim 17 wherein the accelerometer senses movement associated with the smart article dispenser.

22. The smart dispenser system of claim 17 wherein the articles include at least one of pills, capsules, tablets, and caplets.

23. The smart dispenser system of claim 17 wherein the articles include at least one of medication, vitamins, and supplements.

24. The smart article dispenser system of claim 1 wherein the second portion of smart article dispenser information is obtained from at least one of: an RFID tag, physical selection key, physical pattern, and an identification code associated with the smart article dispenser.

25. The smart article dispenser system of claim 24 wherein the device control system includes a look-up table to identify the consumable articles contained in the smart article dispenser based on the second portion of smart article dispenser information.

26. The smart article dispenser system of claim 1 wherein the remote device includes a camera, and the second portion of smart article dispenser information is obtained by taking a picture of at least one of: the consumable articles contained in the smart article dispenser, the smart article dispenser, and a barcode associated with the smart article dispenser.

27. The smart article dispenser system of claim 26 wherein the device control system includes a look-up table to identify the consumable articles contained in the smart article dispenser based on the second portion of smart article dispenser information.

28. The smart article dispenser system of claim 1 wherein the device control system tracks at least one of: a quantity of consumable articles dispensed, a quantity of consumable articles remaining in the smart article dispenser, and consumable article usage patterns.

29. The smart article dispenser system of claim 8 wherein the second portion of smart article dispenser information is obtained from at least one of: an RFID tag, physical selection key, physical pattern, and an identification code associated with the smart article dispenser.

30. The smart article dispenser system of claim 29 wherein the device control system includes a look-up table to identify the consumable articles contained in the smart article dispenser based on the second portion of smart article dispenser information.

31. The smart article dispenser system of claim 8 wherein the remote device includes a camera, and the second portion of smart article dispenser information is obtained by taking a picture of at least one of: the consumable articles contained in the smart article dispenser, the smart article dispenser, and a barcode associated with the smart article dispenser.

32. The smart article dispenser system of claim 31 wherein the device control system includes a look-up table to identify the consumable articles contained in the smart article dispenser based on the second portion of smart article dispenser information.

33. The smart article dispenser system of claim 8 wherein the device control system tracks at least one of: quantity of consumable articles that have been dispensed, quantity of consumable articles remaining in the smart article dispenser, and consumable article usage patterns.

34. The smart article dispenser system of claim 17 wherein the second portion of article information is obtained from at least one of: an RFID tag, physical selection key, physical pattern, and an identification code associated with the smart article dispenser.

35. The smart article dispenser system of claim 34 wherein the device control system includes a look-up table to identify the articles contained in the smart article dispenser based on the second portion of article information.

36. The smart article dispenser system of claim 17 wherein the remote device includes a camera, and the second portion of article information is obtained by taking a picture of at least one of: the articles contained in the smart article dispenser, the smart article dispenser, and a barcode associated with the smart article dispenser.

37. The smart article dispenser system of claim 36 wherein the device control system includes a look-up table to identify the articles contained in the smart article dispenser based on the second portion of article information.

38. The smart article dispenser system of claim 17 wherein the device control system tracks at least one of: quantity of articles that have been dispensed, quantity of articles remaining in the smart article dispenser, and article usage patterns.
